(19) United States
(12) Patent Application Publication
(10) Pub. No.: US 2015/0381520 A1
(43) Pub. Date: Dec. 31, 2015

(54) DATA SET MULTIPLICITY CHANGE DEVICE, SERVER, DATA SET MULTIPLICITY CHANGE METHOD AND COMPUTER REDABLE MEDIUM

(71) Applicant: NEC Corporation, Minato-ku, Tokyo (JP)

(72) Inventor: Takahiro Watanabe, Tokyo (JP)

(73) Assignee: NEC Corporation, Minato-ku, Tokyo (JP)

(21) Appl. No.: 14/765,437

(22) PCT Filed: Jan. 27, 2014
(86) PCT No.: PCT/JP2014/000374

§ 371 Date: Aug. 3, 2015

(30) Foreign Application Priority Data
Feb. 4, 2013 (JP) 2013-019403

(51) Int. Cl. H04L 12/911; H04L 29/08; H04L 29/06

(52) U.S. Cl. CPC H04L 47/783; H04L 65/40; H04L 67/10

(57) ABSTRACT

A data set multiplicity change device of the invention, after a job is started, the number of data sets (multiplicity M) can be changed so that the access efficiency for accessing multiplicity management target data sets becomes as high as possible. The data set multiplicity change device includes priority degree calculation unit which calculates priority degree information representing an order of a plurality of nodes into which data sets are to be stored, on the basis of data set usage related information including information related to usage of the data sets referred to in a parallel processing executed by the plurality of nodes; and multiplicity management unit which performs multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

### TECHNICAL FIELD

The present invention relates to, for example, a data management technique in a distributed parallel processing system using an information processing device (computer). More particularly, the present invention relates to a multiplicity change technique in multiplex management of data sets.

### BACKGROUND ART

A batch processing is a technique for starting processing on a predetermined timing and repeatedly performing the same processing on given input data by using an information processing device such as a server, thus obtaining a processing result. In recent years, in batch processing, the quantity of processing target data increases, and it is required to reduce processing time. A technique using distributed parallel processing achieved by using multiple servers (nodes) is widely used as a technique for increasing the speed of the batch processing. Hereinafter, an example of such distributed parallel batch processing system will be explained with reference to FIGS. 2 and 4.

FIG. 2 is a configuration diagram illustrating an example of communication environment including a distributed parallel batch processing system which is a related technique. FIG. 4 is a figure illustrating an example of data arrangement in a distributed data store in a distributed parallel batch processing system which is a related technique. FIGS. 2 and 4 are drawings used in an explanation according to a second exemplary embodiment of the present invention, but in this case, a configuration and operation of a general distributed parallel batch processing system, which is a related technique, will be explained using FIGS. 2 and 4.

As shown in FIG. 2, a distributed parallel batch processing system 1 includes three nodes 20 to 22, a distributed parallel batch processing server 10, a master data server 100, a client 500, and a communication network (hereinafter simply abbreviated as “network”) 1000 connecting them.

The three nodes 20 to 22 can execute batch processing divided by the distributed parallel batch processing server 10 in a parallel manner (which may be also expressed as “simultaneous manner”, which is also applicable to the following explanations) in each node. As shown in FIG. 4, each of the nodes 20 to 22 includes memories 40 to 42 and disks 50 to 52.

The distributed parallel batch processing server 10 executes such batch processing by controlling the three nodes 20 to 22.

The client 500 requests the distributed parallel batch processing server 10 to execute batch processing.

The master data server 100 provides master data set 120 to the distributed parallel batch processing server 10, the master data set 120 including input data set including multiple input data, which are processing targets in the batch processing, and reference data set including data group, which is referred to during processing. The master data set 120 is set in the data base 110 in advance.

The distributed parallel batch processing server 10, the nodes 20 to 22, the master data server 100, and the client 500 are general computers operating with program controls.

In this case, premises in this distributed parallel batch processing system (or this may also be referred to as presuppositions) will be explained.

First, a batch processing means that “jobs”, each of which is the minimum processing unit, are executed successively. However, for the sake of simplifying the explanation, the batch processing is considered to include a single job in the following explanation.

Subsequently, even after the job processing is finished, files such as an input data set and a reference data set used by a job executed previously by the nodes 20 to 22 are held, as they are, in the disks 50 to 52 and the memories 40 to 42 of the nodes 20 to 22 until the files are required to be deleted. These data set groups can be reused in execution of a subsequent job if necessary. This is because in the distributed parallel batch processing system, multiple jobs using similar data sets may be executed successively. Examples of such multiple jobs include order reception processing of a merchandize, bill issuing processing for the order, shipping processing of the ordered merchandize, and the like.

As the final premise, a file describing an application program which is a computer program describing processing contents of a job is stored in advance in a disk (not shown) of the distributed parallel batch processing server 10.

Subsequently, the distributed parallel batch processing system according to the related technique will be explained.

In FIG. 2, first, the client 500 requests the distributed parallel batch processing server 10 to execute a job. In the execution request of the job, the client 500 designates an application program name, which is a processing program of the job, and various kind of definition information required for execution of the job. Various kinds of definition information include an input data set name indicating data of processing target of the job, and a reference data set name indicating a data group referred to during the processing. The input data set is, for example, an aggregation of transaction (order and the like) data of any given shop. The reference data set is, for example, an aggregation such as data including information about each merchandize or data defining a discount rate of each merchandize for each day of a week.

Subsequently, the distributed parallel batch processing server 10 having received the execution request of the job divides the input data set, designated in the execution request of the job, into three input data sets A to C which are as many as the number of the nodes 20 to 22. Then, the distributed parallel batch processing server 10 assigns the divided input data sets A to C to the three nodes 20 to 22, respectively, as the processing target of each of the nodes. In general, when the input data set is divided, the distributed parallel batch processing server 10 divides the input data set so that the processing time of each of the divided input data sets A to C becomes as equal as possible. The distributed parallel batch processing server 10 also assigns the divided input data sets A to C to the disks 50 to 52 and the memories 40 to 42 (FIG. 4) of the nodes 20 to 22 on the basis of the arrangement of the read data set. In this case, the distributed parallel batch processing server 10 selects only the node holding data sets required for the processing of the input data sets A to C, and assigns the divided input data sets A to C.

Subsequently, the distributed parallel batch processing server 10 obtains a file associated with the application program name designated in the execution request of the job from the disk of the distributed parallel batch processing server 10, and thereafter starts the program included in the file with the three nodes 20 to 22. A processing entity executing the program describing the processing of the job in the nodes 20 to 22 will be hereinafter referred to as a “task”. More specifically, the processing performed by the tasks 30 to 32 of the nodes 20 to 22, respectively (FIG. 4) are only different in the contents of the input data sets to be processed, and use the same processing (program).

Subsequently, when the data set required for the job processing does not exist in the disks 50 to 52 or the memories 40 to 42 of the nodes 20 to 22, each node performs the following processing. More specifically, each node copies the missing data set via the master data server 100 from the master data set 120 to the disks 50 to 52 or the memories 40 to 42 of the nodes 20 to 22. After the copying of the required data set is finished, each of the tasks 30 to 32 starts the processing in the nodes 20 to 22.

As described above, the distributed parallel batch processing server 10 divides the input data set into three parts, and thereafter, the divided input data sets A to C are processed by the tasks of the three nodes 20 to 22 in a parallel manner, and therefore, the processing time for the entire job can be reduced.

In general, the distributed parallel batch processing system 1, further performs a management called “distributed data store” for uniting the storage devices of the nodes 20 to 22, so that the access efficiency form the tasks 30 to 32 of the nodes 20 to 22 to various kinds of data sets is improved. The “data store” referred to herein is a generic term meaning the destination (a memory or a disk) for holding data on which operation such as generation, reading, updating, and deleting of a data file can be executed in response to a request from the tasks 30 to 32 of the nodes 20 to 22, respectively, and a request from the distributed parallel batch processing server 10.

As shown in FIG. 4, in each of the nodes 20 to 22, the distributed data store 2 includes the memories 40 to 42, the disks 50 to 52, input and output management units 60 to 62, and a management unit, not shown, for managing the entire distributed data store 2. In general, the management unit for managing the entire distributed data store 2 is provided in the distributed parallel batch processing server 10.

In the distributed data store 2, a portion including relatively high speed memories 40 to 42 is referred to as an on-memory type data store 3. On the other hand, in the distributed data store 2, a portion including relatively low speed disks 50 to 52 is referred to as a disk type data store 4. In order to simplify the explanation, the distributed data store 2 according to the present example includes only a storage device locally provided in the nodes 20 to 22, but may also include a file system and a data base executed by a remote computer that can be used via the network 1000.

The tasks 30 to 32 operating in the nodes 20 to 22 access the data stored in the distributed data store 2 via the input and output management units 60 to 62 provided in the nodes 20 to 22. The input and output management units 60 to 62 provide a function for allowing the tasks 30 to 32 transparently to use data in the distributed data store 2 regardless of which storage device of which node (a disk or a memory) the storage destination of the data is.

For example, suppose that the task 30 in the node 20 requests reading of the data set X2 that does exist in neither the memory 40 nor the disk 50 of the node 20. The input and output management unit 60 of the node 20 obtains the data set X2 stored the memory 41 of the node 21 or the memory 42 of the node 22 via the input and output management unit 61 of the node 21 or the input and output management unit 62 of the node 22 on the basis of the request, and thereafter, provides the data of the data set X2 to the task 30. More specifically, the task 30 accesses the data set X2 on the node 21 or the node 22 in accordance with the same access method as the method used in the case where the data set X2 is stored in the node 20 in question. Further, with this function, each the nodes 20 to 22 do not need to include all the data set used for the processing.

In general, the speed at which the task 30 accesses a data set is very faster in the case where the data set exits in the memories 41 to 42 of the other nodes 21 to 22 than in the case where the data set exists in the disk 50 of the node 20 in question. The access speed to a data set for each of the save-locations in the distributed data store 2 depends on the system configuration, but in general, it is in the following relationship using an inequality sign.

(memory of the node in question)>(on-memory type data store another node)>>(disk of the node in question)>(disk type data store of another node)

More specifically, the access speed to the memory of the node in question is the highest speed, and the access speed to the disk type data store of another node is the lowest speed.

In order to improve the access efficiency for accessing the data set group required for the processing when multiple jobs are executed successively, it is effective for the task to reduce the disk access as much as possible due to the property of the distributed data store 2 explained above. More specifically, in order to improve the access efficiency, as many data sets of the data sets required for the processing as possible are desired to be stored in the on-memory type data store 3.

However, in recent years, the quantity of data treated in the processing is increasing. For this reason, the on-memory type data store 3 including the memories 40 to 42 achieved by the semiconductor memory device and the like may not necessarily store all the data sets which are to be processed. On the other hand, in general, the disks 50 to 52 of the nodes achieved by the hard disk device and the like has a storage capacity of 10 to 10000 times larger than the on-memory type data store 3, and therefore, the disks 50 to 52 of the nodes are more likely to be able to store all the data to be processed. Therefore, in general, the on-memory type data store 3 stores some of the data sets, which are more likely to be used commonly by multiple jobs, at all times. Then, when switching to a subsequent job, the distributed parallel batch processing server 10 allocates the processing to the nodes 20 to 22 in accordance with the arrangement situation of the data set in the on-memory type data store 3 at that occasion.

Further, in the on-memory type data store 3, copies of a data set that is stored at all times are held in the memories 40 to 42 of the multiple nodes 20 to 22. In this case, there are mainly two purposes why the data set of the same content is stored in multiple nodes 20 to 22.

The first purpose is to prepare for a situation where it is impossible to access a data set stored in a memory of a particular node when a problem such as damage of a file or a failure of the node occurs, and to increase the reliability of maintenance of data. More specifically, when such problems explained above occur, the task does not access an (alternative) data set stored in the disk, and instead, the task is allowed to access another data set that exists in the memory of another node. Therefore, even when a problem occurs, the task does not need to access a disk of an extremely lower speed than that for the access to the on-memory type data store 3. Therefore, when the task accesses the processing target data set, the access performance is prevented from being reduced extremely.

The second purpose is, when multiple tasks need the same data, each task accesses multiple data sets arranged in a distributed manner in the memories of multiple nodes, so that the reduction of the performance due to access concentration is prevented. In other words, this prevents each task from accessing a single data set, thus preventing access concentration.

In the following explanation, a management method for holding copies of a data set of the same content to the memories 40 to 42 of multiple nodes 20 to 22 included in the on-memory type distributed data store 3 in a distributed manner as described above will be referred to as “multiplicity management”. In the following explanation, a data set as the target of the multiplicity management will be referred to as “multiplicity management target data set”. Further, in the following explanation, the number of copies of the data set provided in the on-memory type distributed data store 3 is denoted by an index “multiplicity M”. For example, when there are two copies of the same data set in the on-memory type distributed data store 3, the multiplicity M is two.

FIG. 4 illustrates an example of arrangement state of data sets in the distributed data store 2 at a point in time when the distributed parallel batch processing server 10 explained above started parallel processing using the tasks 30 to 32 on the nodes 20 to 22. In FIG. 4, two data sets X1 and X2 are multiplicity management target data sets. The multiplicity M is two. In the present example, the value of the same multiplicity M is applied to all the multiplicity management target data sets in order to simplify the multiplicity management.

When FIG. 4 is referred to, totally two data sets X1 are held in the memory 40 of the node 20 and the memory 41 of the node 21 at all times. Totally two data sets X2 are stored in the memory 41 of the node 21 and the memory 42 of the node 22 at all times.

The data sets Y1 to Y4, i.e., data sets which are not the multiplicity management targets (hereinafter referred to as “non-management target”) are stored in the disks 50 to 52 of the nodes 20 to 22, respectively. The input data set divided into three parts, i.e., the input data sets A to C, are arranged according to allocation defined by the distributed parallel batch processing server 10. More specifically, the input data set A, the input data set B, and the input data set C are stored in the disk 50, the disk 51, and the disk 52, respectively. In the present example, the input data sets A to C are non-management targets.

The operating system (OS) operating each of the nodes 20 to 22 controls reading of the data sets of the non-management targets to the memory. More specifically, in response to access requests from the tasks 30 to 32, the OS reads, as necessary, the data sets of the non-management targets into a vacant storage area in the on-memory type data store 3 (more specifically, a storage area that is not occupied to store multiplicity management target data sets).

It is noted that a well-known control method of a memory with the OS includes an LRU (Least Recently Used) algorithm. Basically, in the LRU, when a vacant capacity is insufficient when new data are read to a small-capacity high-speed storage device, the vacant capacity is extended. In this case, in the LRU, data in the high-speed storage device that is not used for the longest time is retracted (moved) to a large-capacity low-speed storage device, so that the vacant capacity is extended. In the present example, the “small-capacity high-speed storage device” and the “large-capacity low-speed storage device” correspond to the “on-memory type data store 3” and the “disk type data store 4”. Therefore, when there are many data sets of the non-management targets required for the processing of the task, the data retraction to the disk performed by the LRU very frequently, and as a result, the processing performance of the task may be reduced.

When the above problem may occur when a new job is executed, the distributed parallel batch processing server 10 may decrease (reduce, cut down) the multiplicity M, thus performing adjustment to increase the vacant area of the on-memory type data store 3. On the contrary, when the distributed parallel batch processing server 10 predicts that there is enough space in the vacant area of the on-memory type data store 3, the distributed parallel batch processing server 10 may raise (increase) the multiplicity M as compared with the current value, thus performing adjustment to increase the reliability of data maintenance.

In normal circumstances, the distributed parallel batch processing server 10 performs changing of the multiplicity M as described above in a preparation stage before the processing of the task on each node is executed, and the distributed parallel batch processing server 10 does not perform the change of the multiplicity M after the processing of the task is once started.

An example of related technique existing before the present application includes the following PTL 1.

More specifically, PTL 1 discloses a mechanism for automatically determining a copy method suitable for various kinds of characteristics of each file for the file to be copied (a storage location, a file type, and the like of the file) chosen from among several file copy methods each have different advantages and disadvantages.

In PTL 2, in a distributed system environment, a batch job inquiry server determines a server requested to perform processing of a batch job based on resource usage characteristics of the batch job of the request target (usage rates of various kinds of resources) and a resource load situation obtained from each job execution server with a regular interval.

In PTL 3, when a calculator for managing arrangement of data and execution of a job executes a job, the calculator determines arrangement of copies to the calculators in accordance with a ratio of the number of records of distributed data arranged in each calculator executing the job. Then, when there is a failure in execution of a job in any given calculator, the calculator executing management requests a calculator having a copy of distributed data arranged in the calculator in which the failure occurs to request execution of the job again.

### CITATION LIST

### Patent Literature

[PTL 1] Japanese National Phase Patent Application Publication No. 2009-526312

[PTL 2] Japanese Patent Application Publication No. H10-334057

[PTL 3] Japanese Patent Application Publication No. 2012-073975

### SUMMARY OF INVENTION

### Technical Problem

However, in operation of a distributed parallel batch processing system, a request for changing the multiplicity M of the multiplicity management target data sets may occur in the middle of execution of a job.

For example, after the job is started, the processing speed reduces, and accordingly, the job may be expected not to finish at an expected end time which is expected by the user. As described above, in general, batch processing (job) in the distributed parallel batch processing system is operated to start processing at any predetermined timing. More specifically, the job is expected to finish by an expected time so that subsequent processing can be started on schedule. When the job is delayed, the reason for this may be a reason that the size and the number of data sets of the non-management target required for the processing of the task exceeds a previous expectation. In this case, in a countermeasure performed after the delay is found, it is effective to increase the vacant area of the on-memory data store 3. More specifically, the distributed parallel batch processing system decreases the multiplicity M of the multiplicity management target data sets in the middle of the job. Therefore, if the processing speed of subsequent job can be increased, the job can be finished earlier than the initial expectation.

On the other hand, after the job is started, the processing of the job may be expected to finish much earlier than expectation. In this case, after the job is determined to be finished earlier, the multiplicity M of the multiplicity management target data sets is increased to improve the reliability of data maintenance, and in this case, the execution of the subsequent jobs becomes further more reliable.

In other case, regardless of the progress of the job itself, the user may want to reduce the quantity of the memory usage on a sudden so as to have the node, which is executing the job, to perform another processing.

As described above, due to various reasons, a request for changing the multiplicity M may occur after the job is started.

However, when the user changes the multiplicity in the middle of the processing, it is difficult to appropriately select a data arrangement that suppresses reduction of the access efficiency for accessing the multiplicity management target data sets as much as possible.

For example, in FIG. 4, there are four methods for reducing the multiplicity M from two to one. More specifically, the first method is a method for leaving the data set X1 of the node 20 and the data set X2 of the node 21. The second method is a method for leaving the data set 1 of the node 20 and the data set X2 of the node 22. The third method is a method for leaving the data set X1 of the node 21 and the data set X2 of the node 23. The fourth method is a method for leaving the data sets X1 and X2 of the node 21.

In this case, for example, assuming that, in the node on which a task performing access to the data set X1 for the largest number of times is operating, the user deletes the data set X1 that was in the memory of the node in question. As a result, when the task subsequently refers to the data set X1, the task has to access the memory in another node after the multiplicity M was changed even though the task was accessing the memory of the node in question until then. More specifically, because the multiplicity M is changed, the processing performance of the task is greatly reduced, and as a result, the entire job may not finish until the expected end time. As described above, under the current circumstances, there is a problem in that the user cannot determine which of the four multiplicity reduction methods explained above is a method capable of avoiding reduction in the access efficiency for accessing the multiplicity management target data sets as much as possible.

The PTLs 1 to 3 explained above is silent on a configuration and a method for solving the above problem.

The present invention is to provide a data set multiplicity change device and a method capable of solving the above problems. More specifically, the main purpose of the present invention is to provide a data set multiplicity change device and a method capable of changing arrangement of multiplicity management target data sets so as to avoid reduction in the access efficiency as much as possible when the multiplicity M is changed duringf processing of a job.

### Solution to Problem

In order to achieve the above object, a data set multiplicity change device which is an aspect of the present invention includes,

priority degree calculation means for calculating priority degree information representing an order of a plurality of nodes into which data sets are to be stored, on the basis of data set usage related information including information related to usage of the data sets referred to in a parallel processing executed by the plurality of nodes; and

multiplicity management means for performing multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

A server which is an aspect of the present invention for achieving the object includes,

a data set multiplicity change device including the above configuration,

wherein parallel processing of the jobs performed by the plurality of nodes is controlled.

A data set multiplicity change method which is an aspect of the present invention for achieving the same object,

calculating, using an information processing device, priority degree information representing an order of a plurality of nodes into which data sets are to be stored, on the basis of data set usage related information including information related to usage of the data sets referred to in a parallel processing executed by the plurality of nodes, and

performing multiplicity change processing to change a multiplicity of the data sets by changing, using the information processing device, a multiplicity of the data set by changing the number of at least one or more data sets held in the plurality of nodes in a distributed manner on the basis of the priority degree information and data set arrangement information indicating a particular node holding the data sets in a storage area thereof.

Further, the object is also achieved by a storage medium for storing a computer program for control of a computer operating as a data set multiplicity change device, wherein the computer program causes the computer execute

priority degree calculation processing for calculating priority degree information representing an order of a plurality of nodes into which data sets are to be stored, on the basis of data set usage related information including information related to usage of the data sets referred to in a parallel processing executed by the plurality of nodes; and

performing multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

### Advantageous Effects of Invention

According to the present invention, after a job is started, the number of data sets (multiplicity M) can be changed so that the access efficiency for accessing multiplicity management target data sets becomes as high as possible.

### BRIEF DESCRIPTION OF DRAWINGS

FIG. 1 is a block diagram illustrating a configuration of a distributed parallel batch processing system including a data set multiplicity change device according to a first exemplary embodiment of the present invention.

FIG. 2 illustrates a communication environment applied to a second exemplary embodiment of the present invention, and is a configuration diagram for explaining an example of a communication environment in a distributed parallel batch processing system which is a related technique.

FIG. 3 is a block diagram illustrating a configuration in a case where the distributed parallel batch processing system according to the second exemplary embodiment is achieved in the communication environment including the configuration as shown in FIG. 2.

FIG. 4 illustrates an example of a data arrangement in a node for explaining the second exemplary embodiment of the present invention, and is a figure for explaining an example of a data arrangement in a distributed data store in a distributed parallel batch processing system which is a related technique.

FIG. 5 is a figure illustrating an example of a job definition information 16 according to the second exemplary embodiment of the present invention.

FIG. 6 is a figure illustrating an example of an input data set according to the second exemplary embodiment of the present invention.

FIG. 7 is a figure illustrating an example of a reference data set X1 which is a multiplicity management target in the second exemplary embodiment of the present invention.

FIG. 8 is a figure illustrating an example of a reference data set Y1 where multiplicity management is not performed according to the second exemplary embodiment of the present invention

FIG. 9 is a flowchart illustrating operation from job deposition processing to job execution processing performed by the distributed parallel batch processing system according to the second exemplary embodiment of the present invention.

FIG. 10 is a flowchart illustrating the details of application analysis processing according to the second exemplary embodiment of the present invention.

FIG. 11 is a flowchart illustrating operation of multiplicity change in the distributed parallel batch processing system according to the second exemplary embodiment of the present invention.

FIG. 12 is a figure illustrating an example of information indicating the number of accesses for each data set obtained by application analysis according to the second exemplary embodiment of the present invention.

FIG. 13 is a figure illustrating an example of a priority degree information 18 according the second exemplary embodiment of the present invention.

FIG. 14 is a figure illustrating an example of data arrangement of the distributed data store after multiplicity change according to the second exemplary embodiment of the present invention.

FIG. 15 is a figure illustrating an example of a configuration of a computer (information processing device) that can be applied to a distributed parallel batch processing system according to each exemplary embodiment of the present invention and a modification thereof.

### DESCRIPTION OF EMBODIMENTS

Subsequently, an exemplary embodiment of the present invention will be explained in details with reference to drawings.

### First Exemplary Embodiment

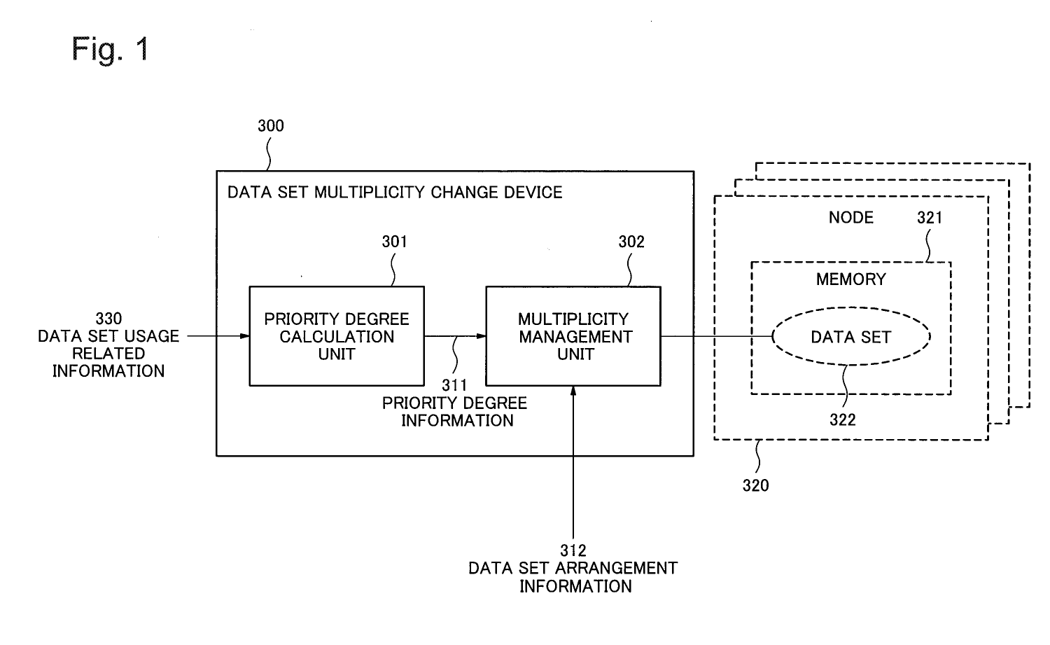

FIG. 1 is a block diagram illustrating of a configuration of a distributed parallel processing system including a data set multiplicity change device according to the first exemplary embodiment of the present invention. As shown in FIG. 1, the distributed parallel processing system includes a data set multiplicity change device 300 and multiple nodes 320.

Multiple nodes 320 can execute each processing obtained by dividing a job as tasks in a parallel manner. Before the job starts, each node 320 can store, to the memory (storage area) 321, a part or all of the data set 322 including the data group referred to by the task during the processing. The distributed parallel processing system can store the number of copies of the data set 322 defined by an index “multiplicity M” to the memories 321 of multiple nodes 320 included in the system in a distributed manner (performs multiplicity management). More specifically, the data set 322 is a data set of multiplicity management target. In the following exemplary embodiments, “the number of data sets” can also be understood as an “amount (quantity)” of data set. From the perspective of taking it as an index (parameter) “multiplicity M”, “the number of data sets” can also be understood as a “numerical value (numerical value)”.

Currently, a general technique can be employed as a division method of a job and a technique according to which each node executes a divided job in a parallel manner as explained in the related technique described above. Therefore, the repeated explanation in the present exemplary embodiment with regard to this point will be omitted.

The data set multiplicity change device 300 includes a priority degree calculation unit 301 and a multiplicity management unit 302.

The priority degree calculation unit 301 obtains data set usage related information 330. Then, the priority degree calculation unit 301 uses the data set usage related information 330 to calculate the priority degree information 311 representing the designation order of the nodes according to which the data are to be stored, i.e., information required to store the data sets 322 to the memories 321 of the nodes 320 in an appropriate order.

In this case, the data set usage related information 330 is a generic term indicating information related to the data set 322 which is the multiplicity management target. The data set usage related information 330 includes, for example, information about a time required for operation such as reference, copy generation, transfer, and the like performed on the data set 322 or information related to the performance. The data set usage related information 330 may include information about setting given from the outside before execution of the job, or information about the number of times of processing executions that can be obtained by performing analysis related to the job processing content. The data set usage related information 330 may include information about a measurement value of a data transfer speed that can be obtained during job execution.

Specific examples of the data set usage related information 330 are considered to be the number of expected accesses for which the task operation on each node 320 accesses the data set 322, a data transfer speed at which data of the data set 322 is transferred from any given node 320 to another node 320, the file size of the data set 322, or the like. The data set usage related information 330 may be information according to the property and the operation environment of the job, and may include information indicating the level (the degree) of the effect given to the access efficiency when a task operating on the node 320 refers to the data set 322.

The priority degree calculation unit 301 calculates the priority degree information 311 in each node 320 by using a function f as shown in the following expression (1) for each data set 322.

f(x1,x2, . . . ,xn)=a1x1+a2x2+ . . . +anxn (1)

In the expression (1), the number of types of data set usage related information 330 is denoted as “n”, and x1, x2, . . . , xn represent the values of the types of data set usage related information 330. The variables a1, a2, . . . , an represent coefficients of the types of data set usage related information 330. More specifically, the function f for determining the priority degree information 311 is a total summation of products of the value of each type of data set usage related information 330 and a coefficient for the type. Therefore, the priority degree calculation unit 301 can calculate the priority degree information 311 by using one or more types of data set usage related information 330. It is noted that there are various modes of calculation expressions for calculating the priority degree 311, and the calculation expression is not limited to the above example. The priority degree calculation unit 301 may use the numerical value of the result of the calculation expression as the priority degree information 311 as it is. Alternatively, the priority degree calculation unit 301 may replace it with a value indicating the order of the magnitude of the numerical value (i.e., making it into 1, 2, 3 . . . in the descending order of the numerical value), and adopt it as the priority degree information 311. When the numerical value of the priority degree information 311 is larger (or smaller), this indicates that the priority degree of the node 320 associated therewith is higher (or lower).

The multiplicity management unit 302 can refer to the data set arrangement information 312 including information indicating what data set 322 is stored in the memory 321 of each node 320.

When the multiplicity management unit 302 receives a request for changing the number of copies of the data set 322 (multiplicity M) from a user and the like after the job was started, the multiplicity management unit 302 uses the priority degree information 311 and the data set arrangement information 312 to determine the node 320 which is adopted as the operation target of the multiplicity change. When there are multiple data sets 322 as the multiplicity management targets, the multiplicity management unit 302 performs the following processing individually for each data set 322.

This will be explained more specifically. When a request for reducing (decreasing) the multiplicity M is received, first, the multiplicity management unit 302 uses the data set arrangement information 312 to find the node 320 where the copy of the data set 322 exists. Subsequently, the multiplicity management unit 302 selects, from among the nodes 320 in which the copies of the data set exist, a node 320 of which priority degree is the lowest in the priority degree information 311, and determines the node 320 as the target for deleting the copy of the data set 322.

On the other hand, when a request for increasing the multiplicity is received, first, the multiplicity management unit 302 uses the data set arrangement information 312 to find the node 320 that does not hold the copy of the data set 322. Subsequently, the multiplicity management unit 302 selects, from among the nodes 320 that does not hold the copy of the data set, a node 320 of which priority degree is the highest in the priority degree information 311, and determines the node 320 as the target for adding the copy of the data set 322.

Finally, the multiplicity management unit 302 performs operation of multiplicity change on the memory 321 in the node 320 that is determined to be the target of the multiplicity change. More specifically, the multiplicity management unit 302 executes reduction or adding of the copy of the data set 322 from or to the memory 321.

As described above, according to the present exemplary embodiment, after the job is started, the data set multiplicity change device 300 can change the multiplicity so that the access efficiency for accessing the data set 322 which is the multiplicity management target becomes as high as possible. This is because the multiplicity management unit 302 can determine the node 320 adopted as the operation target of the multiplicity change, on the basis of the priority degree information 311 about each node 320 calculated on the basis of the data set usage related information 330 by the priority degree calculation unit 301.

In addition, according to the present exemplary embodiment, even when a request for multiplicity change is received from a user and the like after the job is started, there is an advantage in that the data set multiplicity change device 300 can quickly carry out the multiplicity change. This is because the priority degree calculation unit 301 calculates the priority degree information 311 in advance, and accordingly, when the multiplicity management unit 302 receives a change request, the multiplicity management unit 302 can quickly determine the node 320 adopted as the operation target of the multiplicity change by using the priority degree information 311.

### Second Exemplary Embodiment

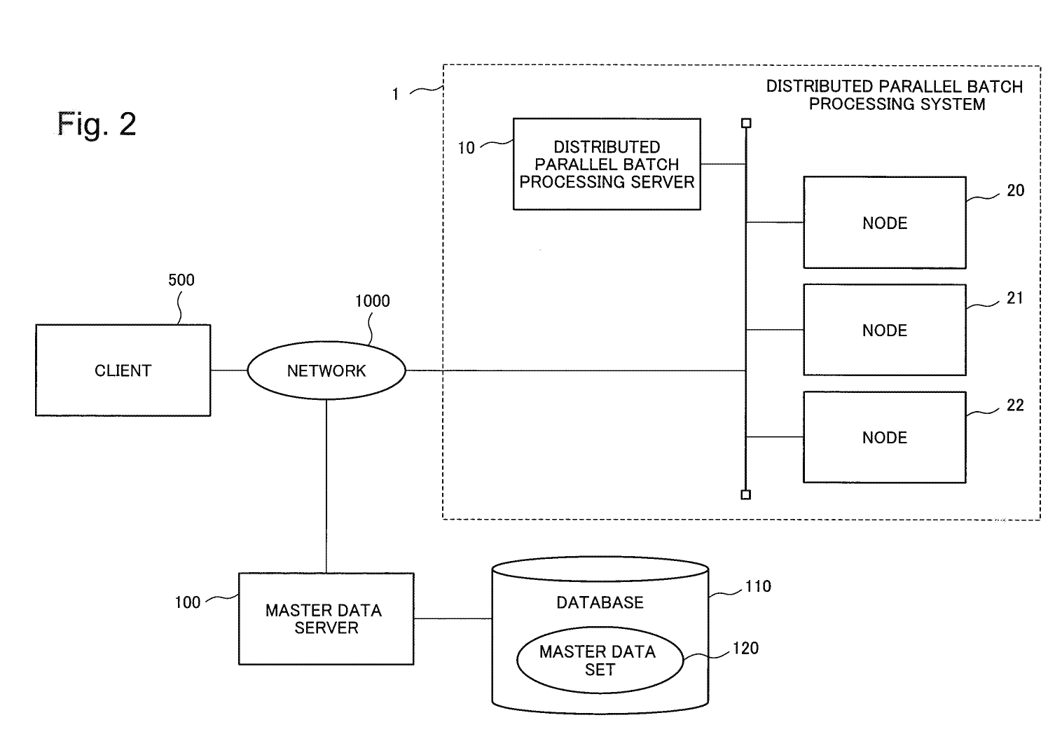

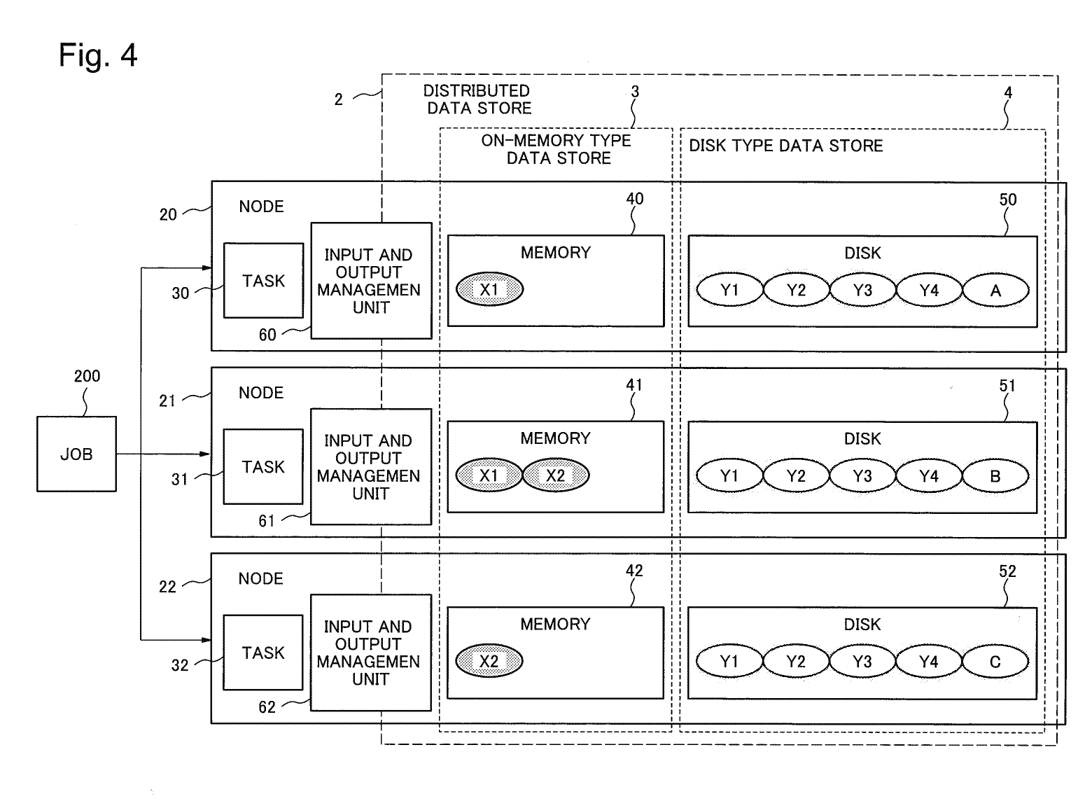

Subsequently, the second exemplary embodiment based on the first exemplary embodiment explained above will be explained with reference to FIGS. 2 to 14. It is noted that the present exemplary embodiment is also an example where the communication environment (FIG. 2, FIG. 4) including the distributed parallel batch processing system 1 explained as a related technique is used. More specifically, in the present exemplary embodiment, it is assumed that general component parts of the distributed parallel batch processing system such as the presupposition, the structure of the distributed data store, and the parallel execution of a job using a task of a distributed parallel batch processing system which are the same as the related technique are considered to be the same as the related technique.

In the following explanation, distinctive portions of the second exemplary embodiment will be mainly explained with reference to Figs. and 4, and detailed explanation about the general operation of the distributed parallel batch processing system explained as the related technique will not be explained repeatedly.

FIG. 2 is a configuration diagram illustrating an example of a communication environment in a distributed parallel batch processing system according to the second exemplary embodiment of the present invention. As shown in FIG. 2, the present exemplary embodiment includes a distributed parallel batch processing system 1 including three nodes 20 to 22 and a distributed parallel batch processing server 10, a master data server 100, a client 500, and a network 1000. In this case, the nodes 20 to 22 are associated with the multiple nodes 320 of the first exemplary embodiment.

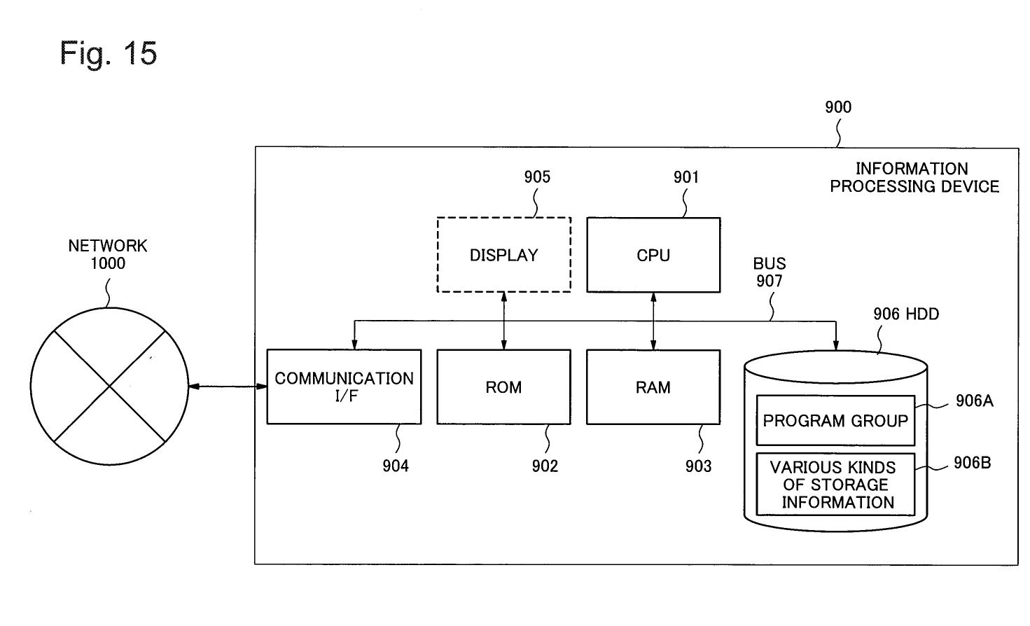

Each of the distributed parallel batch processing server 10, the nodes 20 to 22, the master data server 100, and the client 500 of the present exemplary embodiment may include a general computer (information processing device) operating with a program control, or may include a dedicated hardware circuit. An example of hardware configuration in a case where the distributed parallel batch processing server 10 is achieved by a computer will be explained later with reference to FIG. 15.

The distributed parallel batch processing server 10, the nodes 20 to 22, the master data server 100, and the client 500 can communicate with each other via a network (communication network) 1000 such as the Internet and a LAN (local area network).

The client 500 transmits a job deposition request for requesting preparation of execution of a job and a job execution request for requesting start of execution of a job to the distributed parallel batch processing server 10. After the start of processing of a job in the distributed parallel batch processing system 1, the client 500 transmits a multiplicity change request for requesting an increase or a reduction of the multiplicity M of the multiplicity management target data set to the distributed parallel batch processing server 10 as necessary.

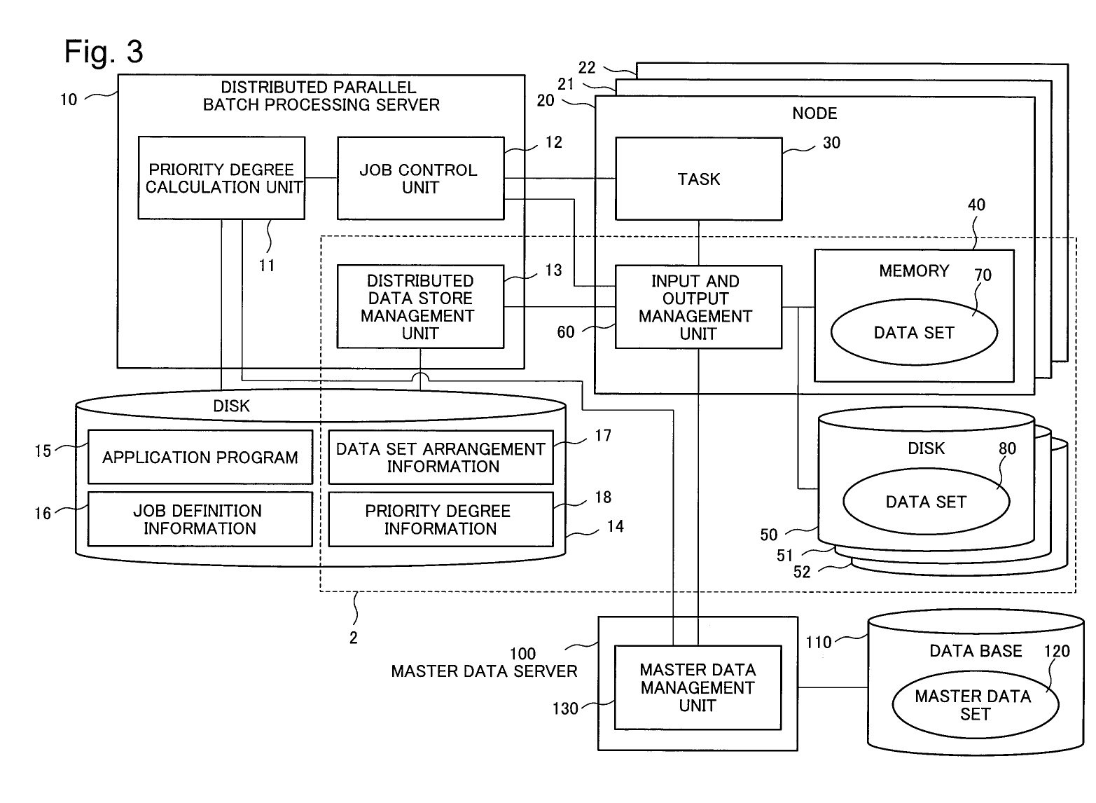

The configuration of the distributed parallel batch processing server 10, the nodes 20 to 22, and the master data server 100 of the second exemplary embodiment will be explained with reference to FIGS. 3 and 4. FIG. 3 is a block diagram illustrating of a distinctive configuration in a case where the distributed parallel batch processing system according to the second exemplary embodiment is achieved in the communication environment including the configuration as shown in FIG. 2. As shown in FIGS. 3 and 4, each of the three nodes 20 to 22 includes tasks 30 to 32, memories (storage areas) 40 to 42, disks 50 to 52, input and output management units 60 to 62.

The tasks 30 to 32 are processing entity executing the program describing the processing of the job which is the execution target of the job execution request in a parallel manner. The structure and the operation of the tasks 30 to 32 are the same as the related technique, and therefore, detailed explanation thereabout is omitted.

The memories 40 to 42 are achieved by semiconductor memory devices of which speed is higher than the disks 50 to 52 explained later. The memories 40 to 42 can store data sets required for execution of a job.

The disks 50 to 52 are achieved by disk devices of which speed is lower than the memories 40 to 42. The disks 50 to 52 can store data sets required for execution of a job.

The input and output management units 60 to 62 can control input and output of data stored in the memories 40 to 42 and the disks 50 to 52 of the nodes.

The structures and the operations of the memories 40 to 42, the disks 50 to 52, and the input and output management units 60 to 62 are the same as those of the related technique. More specifically, the input and output management units 60 to 62 can provide the tasks 30 to 32 with an access function that can be used without being aware of the location where the data exists regardless of which storage device of which node the storage destination of the data is. As explained in the related technique, the storage devices of the nodes 20 to 22 are managed to be integrated with each other, so that the distributed data store 2 as shown in FIG. 4 can be made. Therefore, the on-memory type data store 3 in the present exemplary embodiment includes, for example, the memories 40 to 42 of the nodes 20 to 22. The disk type data store 4 in the present exemplary embodiment includes, for example, the disks 40 to 42 of the nodes 20 to 22.

As shown in FIG. 3, in the present exemplary embodiment employing the communication environment as shown in FIG. 2, the distributed parallel batch processing server 10 includes a priority degree calculation unit 11, a job control unit 12, a distributed data store management unit 13, and a disk 14.

It is noted that distributed parallel batch processing server 10 is associated with (based on) the data set multiplicity change device 300 of the first exemplary embodiment. The priority degree calculation unit 11 is associated with (based on) the priority degree calculation unit 301 of the first exemplary embodiment. Further, the distributed data store management unit 13 is associated with (based on) the multiplicity management unit 302 of the first exemplary embodiment.

The disk 14 can be accessed from the priority degree calculation unit 11 and the distributed data store management unit 13. The disk 14 can store an application program 15, job definition information 16, data set arrangement information 17, and priority degree information 18. The distributed parallel batch processing server 10 stores the application program 15, the job definition information 16, and the data set arrangement information 17 to the disk 14 before the client 500 transmits a job deposition request. The priority degree information 18 is generated by the priority degree calculation unit 11.

The application program 15 is a computer program describing processing contents of a job.

The job definition information 16 is information describing various kinds of definitions required for the job execution. More specifically, the job definition information 16 includes information designating the name of the application program 15 which is the processing content of the job, an input data set name which is the processing target of the job, and a reference data set name referred to during the job processing.

The data set arrangement information 17 includes information indicating arrangement in the on-memory type data store 3 of each multiplicity management target data set. More specifically, the data set arrangement information 17 is information indicating the nodes 20 to 22 each storing the multiplicity management target data set. It is noted that the data set arrangement information 17 may include arrangement information of a data set as a non-management target. The data set arrangement information 17 may include arrangement information about the data sets of the disks 50 to 52.

The priority degree information 18 is information required to store the multiplicity management target data sets to the memories 40 to 42 of the nodes 20 to 22 in an appropriate order, and is information representing the designation order of the nodes according to which the data are to be stored.

First, the priority degree calculation unit 11 performs analysis on the basis of information about the input data set obtained from the job definition information 16, the application program 15, and the master data server 100 (explained later), thus obtaining information about the predicted number of accesses for each data set (analysis information). In the present exemplary embodiment, an example of analysis information calculated by the priority degree calculation unit 11 is the predicted number of accesses for each data set, but the analysis information calculated by the priority degree calculation unit 11 is not limited thereto. The information about the predicted number of accesses for each data set (hereinafter referred to as “the predicted access number information”) is information indicating the expected number of times each multiplicity management target data set is accessed when the tasks 30 to 32 execute the processing of the job.

Subsequently, the priority degree calculation unit 11 calculates the priority degree information 18 by using the predicted access number information for each data set thus obtained. The calculated priority degree information 18 is stored to the disk 14. It is noted that the predicted access number information for each data set and the priority degree information 18 are associated with the data set usage related information 330 and the priority degree information 311 of the first exemplary embodiment.

The job control unit 12 receives various kinds of requests from the client 500, and controls each unit of the distributed parallel batch processing server 10 and the nodes 20 to 22 in accordance with the received request.

The distributed data store management unit 13 centrally manages information about the data sets held in the distributed data store 2 (FIG. 4). The information about the data set includes, for example, the name of each data set, arrangement information indicating the storage location, and the like.

The distributed data store management unit 13 changes the multiplicity M of the multiplicity management target data sets in accordance with the command given by the job control unit 12 receiving a multiplicity change request from the client 500. More specifically, the distributed data store management unit 13 determines the nodes 20 to 22 which are adopted as the target of addition or deletion of data (one or more of the nodes 20 to 22) for each multiplicity management target data set on the basis of the priority degree information 18 and the data set arrangement information 17 stored in the disk 14. Then, the distributed data store management unit 13 performs addition or deletion of each multiplicity management target data set in the determined memories 40 to 42 of the nodes 20 to 22 via the input and output management unit 60 of each node. The distributed data store management unit 13 also updates the data set arrangement information 17 when the multiplicity management target data set is added or deleted.

As shown in FIG. 3, the master data server 100 includes a data base 110 and a master data management unit 130.

The data base 110 can store the master data set 120.

The master data set 120 includes an input data set including multiple input data which is processing target of a job, and a reference data set including a data group referred to during the processing.

The data base 110 and the structure and the content of the master data set 120 are the same as those of the related technique, and therefore, the detailed explanation is not repeatedly explained.

The master data management unit 130 can provide the data set included in the master data set 120 in accordance with the request from the distributed parallel batch processing server 10 and the nodes 20 to 22. The master data management unit 130 can also provide information about the data set stored in the master data set 120 in accordance with the request from the distributed parallel batch processing server 10 and the nodes 20 to 22. The information is the number of data included in the data set, the data size, and the like.

Subsequently, the distributed parallel batch processing system according to the present exemplary embodiment including the above configuration is operated almost as described below.

More specifically, the job control unit 12 in the distributed parallel batch processing server 10 according to the present exemplary embodiment executes processing in the execution procedure of the job that corresponds to the procedure executed by the distributed parallel batch processing server 10. On the other hand, in the step before the execution of the job is started, the priority degree calculation unit 11 calculates the priority degree information 18, and stores the priority degree information 18 to the disk 14. When multiplicity change is requested from the client 500 during the processing of the job, the distributed data store management unit 13 receives the request via the job control unit 12. Further, as a response result in reply to the request, the distributed data store management unit 13 changes the multiplicity on the basis of the priority degree information 18 stored in the disk 14 and the data set arrangement information 17 at the point in time when the request is received.

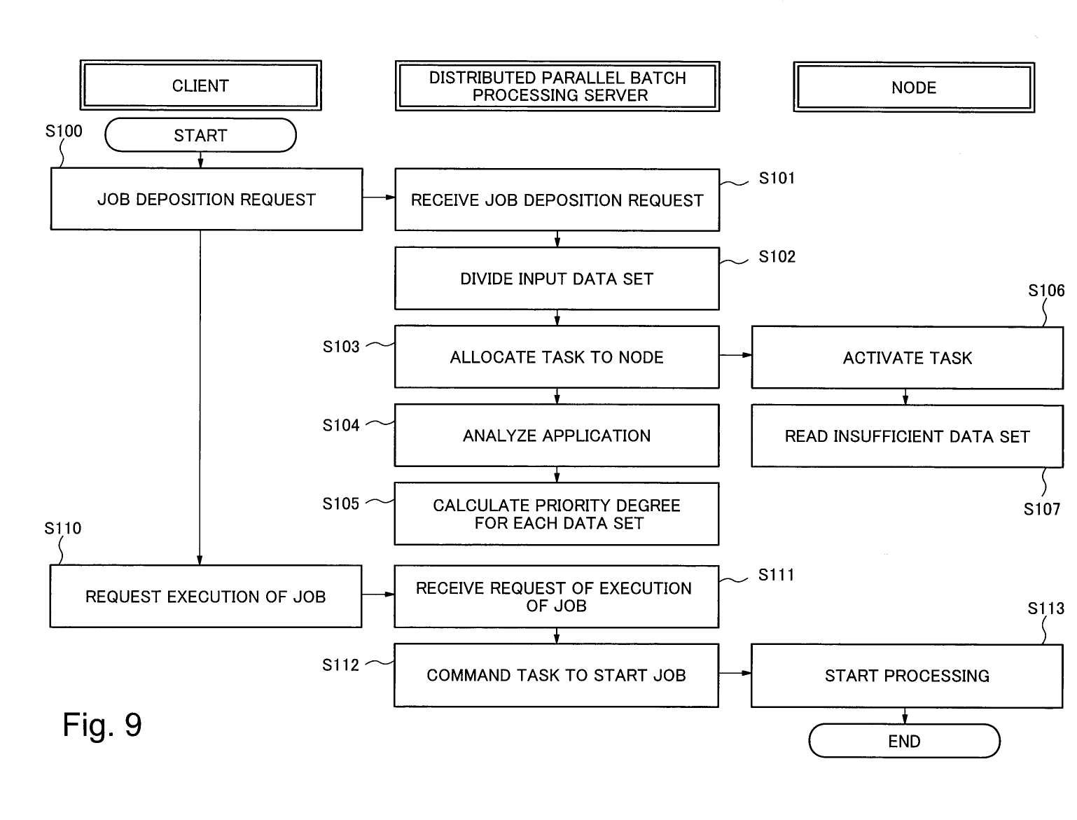

Subsequently, the details of the processing from the deposition of the job (preparation of execution) to the execution of the job performed by the priority degree calculation unit 11 and the job control unit 12 in the distributed parallel batch processing server 10 will be explained with reference to FIG. 9. FIG. 9 is a flowchart illustrating operation from the job deposition processing to the job execution processing performed by the distributed parallel batch processing system according to the second exemplary embodiment of the present invention.

As described above, premise matters according to the present exemplary embodiment are the same as those of the distributed parallel batch processing system of the related technique. More specifically, in the nodes 20 to 22, files such as the input data set, the reference data set, and the like used in the job processing executed previously are held as they are in the distributed data store 2. Accordingly, it is assumed that the content of the data set arrangement information 17 at the point in time when the operation according to the present exemplary embodiment starts is considered to be in consistent with the arrangement situation of the data set held in the distributed data store 2 at that moment.

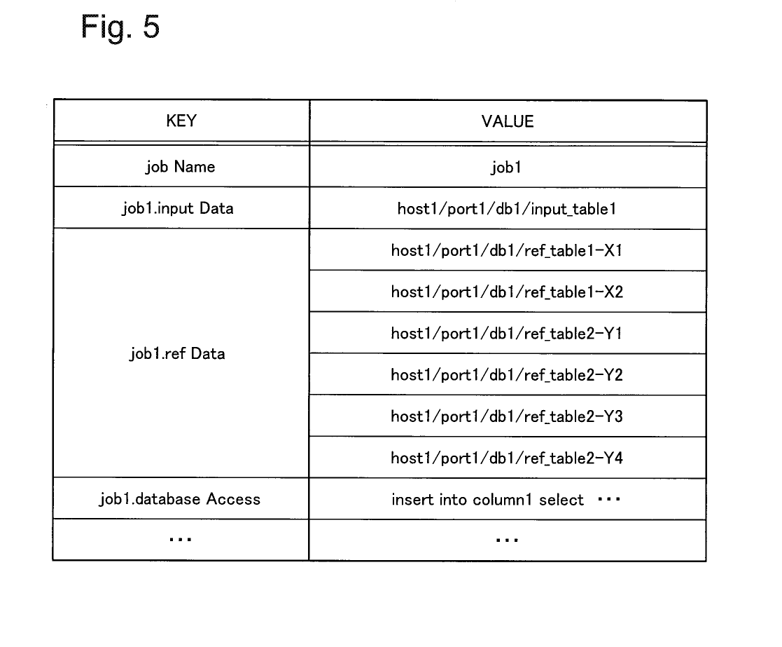

First, the client 500 transmits the deposition request of the job to the distributed parallel batch processing server 10 (step S100). In the deposition request of the job, the client 500 designates the job definition information 16 including various kinds of definition information required for execution of the job. FIG. 5 is an example of the job definition information 16 according to the second exemplary embodiment of the present invention.

As shown in FIG. 5, the records of the job definition information 16 includes a “key” column indicating the type of the definition information and a “value” column indicating the content of the definition information. In this case, in a “value” column of a record where the “key” column is “jobName” (hereinafter denoted as a key “jobName”), an application program name indicating an application program 15 describing a processing content of a job is designated. The application program name according to the present exemplary embodiment is “job1”. In the “value” column of a record including key “job1.inputData”, the name of input data set which is the processing target of the job is designated. The name of the input data set according to the present exemplary embodiment is “host1/port1/db1/input_table1”. In the “value” column of a record including key “job1.refData”, the name of the reference data set referred to during the job processing is designated. The name of the reference data set according to the present exemplary embodiment describes the names of the six reference data sets using six character strings such as “host1/port1/db1/ref_table1-X1” and the like.

In the following explanation, for example, the data set “host1/port1/db1/ref_table1-X1” is denoted as “data set X1” using two characters at the end. The other reference data sets are described in the same manner. More specifically, the reference data sets according to the present exemplary embodiment are six data sets, i.e., data sets X1, X2, Y1, Y2, Y3, and Y4.

The job definition information 16 may include information other than the above. For example, in the present exemplary embodiment, in the record including key “job1.databaseAccess”, the output destination of the processing result of the job is designated.

In the present exemplary embodiment, the multiplicity management target data sets are two data sets of data sets used for the processing (the input data set and the reference data sets), which are more specifically a data set X1 and a data set X2. The multiplicity M is two. More specifically, at the point in time when the operation explained below starts, the data sets X1 and X2 are in the state of being arranged in a distributed manner in such a manner that two data sets of each of them are arranged respectively in two of the memories 40 to 42 provided in the nodes 20 to 22. More specifically, as shown in FIG. 4, the data set X1 is arranged in the node 20 and the node 21. The data set X2 is arranged in the node 21 and the node 22.

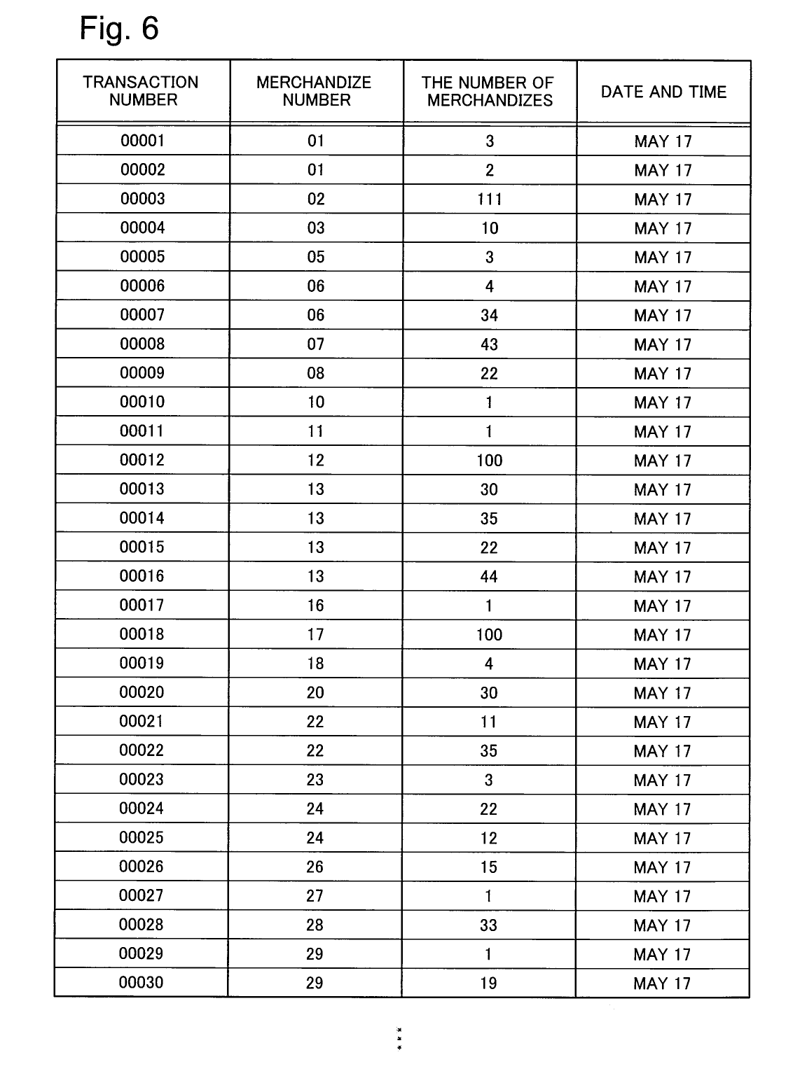

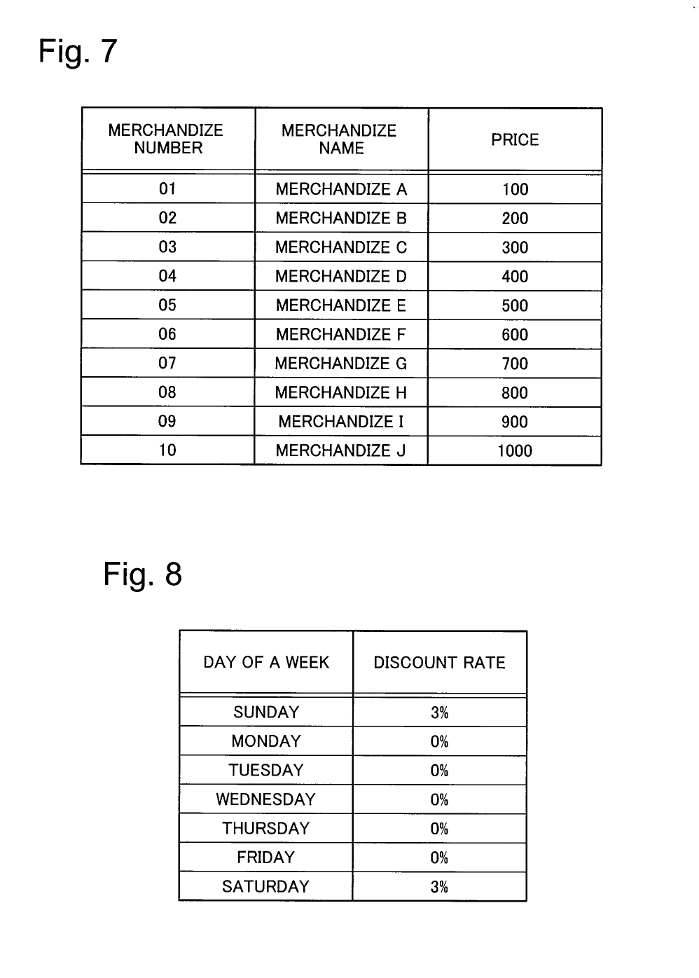

In this case, a specific example and processing content of a data set used for processing of a job according to the present exemplary embodiment will be explained with reference to FIG. 6 to FIG. 8. FIG. 6 is an example of an input data set according to the second exemplary embodiment of the present invention. FIG. 7 is an example of the reference data set X1 which is the multiplicity management target according to the second exemplary embodiment of the present invention. FIG. 8 is an example of the reference data set Y1, on which the multiplicity management is not performed, according to the second exemplary embodiment of the present invention.

The content of the input data set according to the present exemplary embodiment is an input data set indicating transactions (orders) in any given shop. As shown in FIG. 6, the input data include a “transaction number” column, a “merchandize number” column, “the number of pieces” column, and a “date and time” column. The “transaction number” column includes a number uniquely identifying each transaction in the shop. The “merchandize number” column includes a number indicating an ordered merchandize. “The number of pieces” column includes the number of ordered merchandizes. The “date and time” column includes a date when a merchandize is ordered. It is assumed that there are 3000 input data included in the input data set “host1/port1/db1/input_table1”.

The contents of the reference data sets according to the present exemplary embodiment include two types, which are a merchandize data, i.e., information about merchandizes (data sets Xn, n=1 to 2), and discount rate data of a merchandize price for days of a week (data set Yn, n=1 to 4). As shown in FIG. 7, the merchandize data included in the data set X1 include a “merchandize number” column, a “merchandize name” column, and a “price” column. The “merchandize number” column includes a number uniquely identifying a merchandize. The “merchandize name” column includes the name of the merchandize. The “price” column include the unit price of the merchandize. The data set X2 includes the same structure as the data set X1, but includes merchandize data in the merchandize number band different from the data set X1. For example, the data set X1 includes the first to 999th merchandize data. On the other hand, the data set X2 includes the 1000ths merchandize data.

As shown in FIG. 8, the discount rate data included in the data set Y1 includes a “day of a week” column and a “discount rate” column. The “day of a week” column indicates a day of a week when a discount is applied to a merchandize. The “discount rate” column indicates a value in unit of percent of a discount rate applied to a merchandize. The data sets Y2 to Y4 are in the same structure as the data set Y1, but includes discount rate data applied to a transaction of a condition different from the data set Y1. For example, both of the data sets Y1 and Y2 are applied to transaction of merchandizes of which merchandize numbers are 01 to 999. On the other hand, the data set Y2 is applied only to a transaction of which total price of the transaction is equal to or more than 10,000 yen. Likewise, the data sets Y3 to Y4 also have difference in that the merchandize number band and the total price condition for applying the discount rate are different.

In the following explanation, a processing content of a job name “job1” according to the present exemplary embodiment (i.e., an application program “job1”) will be explained using an example of processing performed on the first input data of the input data set as shown in FIG. 6 (a transaction number “00001”, a merchandize number “01”, the number of pieces “3”, and date and time “May 17”). In this case, “May 17” is Sunday.

A task executing the application program “job1” (hereinafter referred to as a task 30J) reads input data from the input data set one by one, and outputs the amount of sales of the transaction indicated by each input data thus read. More specifically, the task 30J accesses the reference data set X1 including the merchandize data of the merchandize number “01”, thereby obtaining price “100” yen associated therewith. Subsequently, the task 30J calculates the total price (100 yen*3 pieces=300 yen) on the basis of the obtained price and the number of pieces of the input data. Subsequently, the task 30J accesses the reference data set Y1 including the discount rate data associated with the calculated total price “300” yen, thus obtaining the discount rate “3%” applied to the date and time “May 17” (Sunday). Finally, the task 30J outputs, as a processing result, the amount of sales “291” yen obtained by applying the obtained discount rate “3%” to the total price “300” yen. More specifically, in the processing of the application program “job1”, a single access occurs for each of any one of the data sets Xn and any one of the data sets Yn for a single input data. Hereinafter, the deposition processing of the job in the distributed parallel batch processing for executing such task will be further explained in details.

The explanation will be explained again with reference to FIG. 9.

In the distributed parallel batch processing server 10, the job control unit 12 receives a deposition request of a job (step S101). Then, the job control unit 12 obtains the name of the input data set from the job definition information 16 designated in the deposition request of the job. More specifically, the job control unit 12 obtains, as the name of the input data set, a character string “host1/port1/db1/input_table1” stored in the “value” column associated with the key “job1.inputData” in the job definition information 16 (FIG. 5).

Subsequently, the job control unit 12 divides the designated input data set into three input data sets A to C in accordance with the number of nodes 20 to 22 (step S102). In this case, the division method of the input data set is, for example, a method for dividing the input data set on the basis of the number of input data included in the input data set. More specifically, first, the job control unit 12 requests the master data management unit 130 of the master data server 100 to send the total number of data included in the input data set “host1/port1/db1/input_table1”, and obtains the number of data (3000) as a response thereto. Then, the job control unit 12 divides the (3000) input data into three to make the input data into input data sets A to C each including 1000 input data.

Subsequently, the job control unit 12 allocates (designates) the divided input data sets A to C to the three nodes 20 to 22 respectively as the processing target of the nodes. Then, the job control unit 12 commands the three nodes 20 to 22 to activate the task (step S103). Like the execution procedure of the job explained in the related technique, the job control unit 12 allocates the divided input data sets A to C so that the data sets already arranged in the distributed data store 3 are effectively used. More specifically, the job control unit 12 determines the nodes to which the input data sets A to C are allocated, on the basis of the name of the reference data set obtained from the job definition information 16 and the arrangement information of the data sets obtained from the data set arrangement information 17 or the distributed data store management unit 13. In this case, assuming that the job control unit 12 allocates the input data set A to the node 20, allocates the input data set B to the node 21, and allocates the input data set C to the node 22, respectively.

The nodes 20 to 22 commanded to activate the task activate the tasks 30 to 32, respectively, on the nodes (step S106).

Thereafter, the tasks 30 to 32 reads the lacking data set via the input and output management unit 60 from the master data server 100 (step S107). More specifically, the tasks 30 to 32 obtains the reference data set and input data sets A to C which have not yet read into the distributed data store 3 from the data base 110 connected to the master data server 100. The tasks 30 to 32 waits until a command of a job start is given after the required data sets have been read.

The arrangement state of the data sets in the distributed data store 2 at the point in time when step S107 is finished is what is shown in FIG. 4. More specifically, the state of the distributed data store 2 before the job execution start according to the present exemplary embodiment is the same as that of the related technique.

On the other hand, after the job control unit 12 executes the processing described in step S103 in the distributed parallel batch processing server 10, the priority degree calculation unit 11 performs the application analysis (step S104).

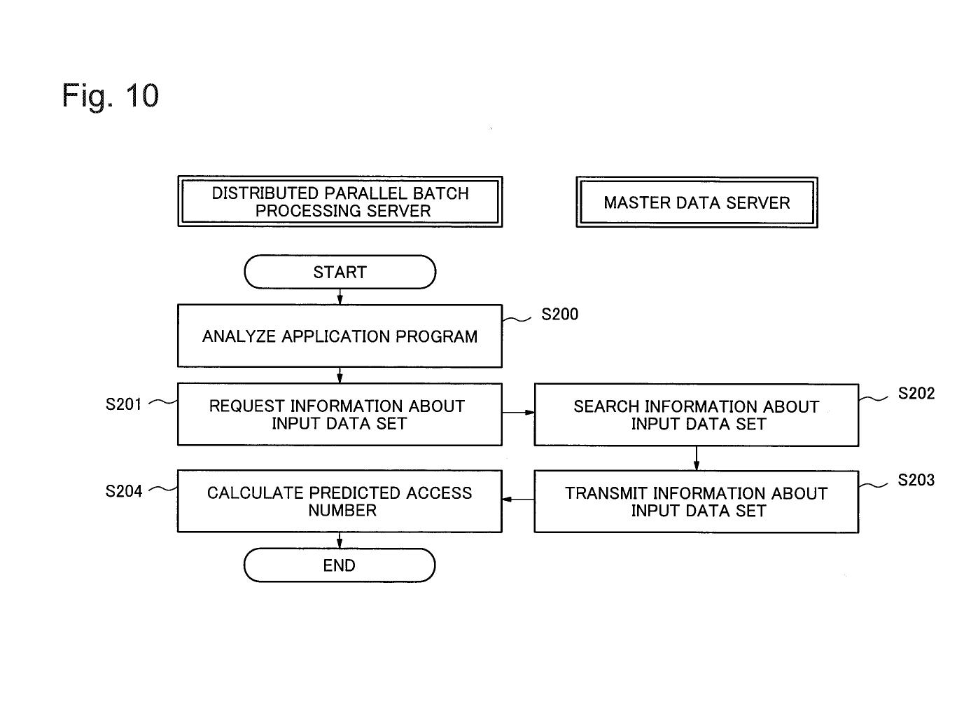

The application analysis processing according to the present exemplary embodiment corresponds to the processing of the first exemplary embodiment in which the priority degree calculation unit 301 obtains the data set usage related information 330. In this case, the details of the application analysis processing of the priority degree calculation unit 11 (step S104) will be explained with reference to FIG. 10. FIG. 10 is a flowchart illustrating the details of application analysis processing according to the second exemplary embodiment of the present invention.

First, the priority degree calculation unit 11 obtains the application program name, the name of the input data set, the name of the reference data set from the job definition information 16. Further, the priority degree calculation unit 11 obtains information about the input data sets A to C allocated to the nodes 20 to 22 from the job control unit 12. Then, the priority degree calculation unit 11 analyzes what kind of processing is performed on the input data set by the application program 15 designated by the application program name (application program “job1”) on the basis of the obtained information.

In the present exemplary embodiment, for example, the priority degree calculation unit 11 analyzes the portion of the application program 15 where the processing is performed on the input data set, and predicts the number of times each multiplicity management target data set is accessed that is carried out during the processing. More specifically, the priority degree calculation unit 11 obtains (calculates), as a result of the application analysis, the predicted access number information for each multiplicity management target data set (hereinafter referred to as “the expected access number information for each data set”). “The predicted access number information for each data set” indicates the degree as to how much the access to each data set is required (the degree of necessity) during the execution of the application program 15, and therefore, as described above, “the predicted access number information for each data set” is associated with the data set usage related information 330 according to the first exemplary embodiment.

For the analysis, the priority degree calculation unit 11 obtains information about the data sets (the input data set and the reference data sets) used by the processing of the application program 15 from the master data management unit 130, and may use the information for the analysis.

More specifically, the priority degree calculation unit 11 analyzes the application program 15, and finds out that a single access occurs for each of the data sets Xn including the merchandize data associated with the “merchandize number” column in each input data (step S200). Subsequently, the priority degree calculation unit 11 obtains the number of input data of which “merchandize number” column are 1 to 999 with regard to the input data set A from the master data management unit 130. More specifically, the priority degree calculation unit 11 requests the master data management unit 130 to send information about the input data set A (step S201). Subsequently, the master data management unit 130 searches information about the input data set A on the basis of the request (step S202). Then, the master data management unit 130 transmits the searched input data set A to the priority degree calculation unit 11 (step S203). The priority degree calculation unit 11 adopts the total number of data (1000 data) of the obtained input data set A as the number of expected accesses for accessing the data set X1 in the processing of the input data set A (i.e., the processing with the node 20 to which the input data set A is allocated). Further, the priority degree calculation unit 11 adopts the number (zero) obtained by subtracting the number of expected accesses (1000) for accessing the data set X1 from the total number of data (1000) of the input data set A as the number of expected accesses for accessing the data set X2 (step S204).

Likewise, the priority degree calculation unit 11 also calculates the number of expected accesses for accessing the data set Xn with regard to the input data set B and the input data set C (i.e., the node 21 and the node 22).

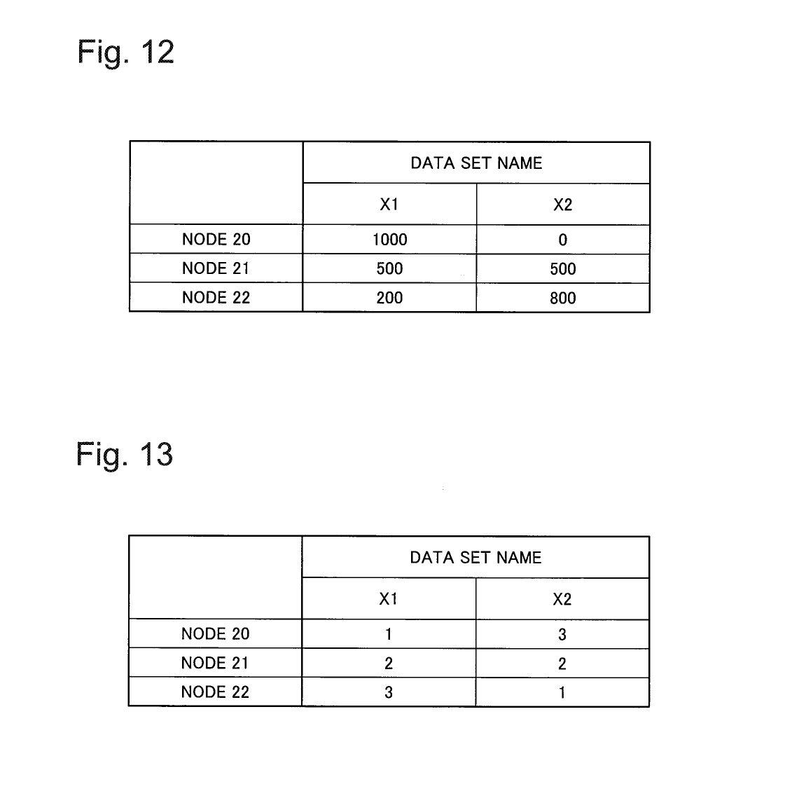

In the present exemplary embodiment, it is assumed that the priority degree calculation unit 11 already notified of, e.g., the range of the merchandize numbers associated with the data sets Xn and that the multiplicity management target data sets include the data set X1 and the data set X2. An example of result of such application analysis is shown in FIG. 12. (The details of FIG. 12 will be explained later).

The operation will be explained again with reference to FIG. 9.

The priority degree calculation unit 11 calculates the priority degree information 18 for each multiplicity management target data set on the basis of “the predicted access number information for each data set” obtained by the application analysis (step S105). The priority degree information for each data set according to the present exemplary embodiment is determined in the descending order of the value of the result (hereinafter referred to as “temporary degree”) calculated by the following priority degree calculation expression (expression (2)) in accordance with a method for giving a higher priority degree to a node associated with a higher temporary degree.

f(x)=a1x1 (2)

In this case, “x1” which is a value for each type of the data set usage related information 330 is “the predicted number of accesses for each data set”. On the other hand, “a1” which is a coefficient for each type of the data set usage related information 330 is “1”. More specifically, in the present exemplary embodiment, the priority degree calculation unit 11 gives a higher priority degree in the descending order of the predicted number of accesses for each data set.

A specific calculation processing of the priority degree will be explained with reference to FIG. 12. FIG. 12 is an example of information indicating the predicted number of accesses for each data set obtained in the application analysis according to the second exemplary embodiment of the present invention.

First, the priority degree calculation unit 11 calculates the temporary degree for each of the nodes 20 to 22 with regard to the data set X1. As shown in FIG. 12, the temporary degrees of the data set X1 are 1000, 500, 200 for the nodes 20 to 22, respectively. Subsequently, the priority degree calculation unit 11 give the priority degrees, e.g., 1, 2, 3 . . . , to the nodes in the descending order of the value of the temporary degree. More specifically, the priority degrees with regard to the data set X1 are “1”, “2”, “3” for the nodes 20 to 22, respectively. Likewise, with regard to the data sex X2, the priority degree calculation unit 11 also calculates the priority degrees for the nodes 20 to 22. The priority degrees of the data set X2 are “3”, “2”, “1” for the nodes 20 to 22, respectively.

The priority degree calculation unit 11 stores, as the priority degree information 18, information about the priority degree about each multiplicity management target data set thus calculated to the disk 14. FIG. 13 is an example of the priority degree information 18 according to the second exemplary embodiment of the present invention.

The job deposition processing performed by the distributed parallel batch processing server 10 is completed hereinabove. In this case, the job control unit 12 may notify the completion of the job deposition processing to the client 500.

Subsequently, after the client 500 receives an end notification of job deposition processing or after a sufficient time passes since a job deposition processing request, the client 500 transmits an execution request of a job adopted as a target in a job deposition request to the distributed parallel batch processing server 10 (step S110).

In the distributed parallel batch processing server 10, the job control unit 12 receives the execution request of the job (step S111). Then, the job control unit 12 commands the tasks 30 to 32 waiting in the nodes 20 to 22 to start the job (step S112).

The tasks 30 to 32 commanded to start the job starts processing of the job (step S113).

What has been described above is processing from the deposition of the job (preparation of execution) to the execution of the job in the distributed parallel batch processing server 10.

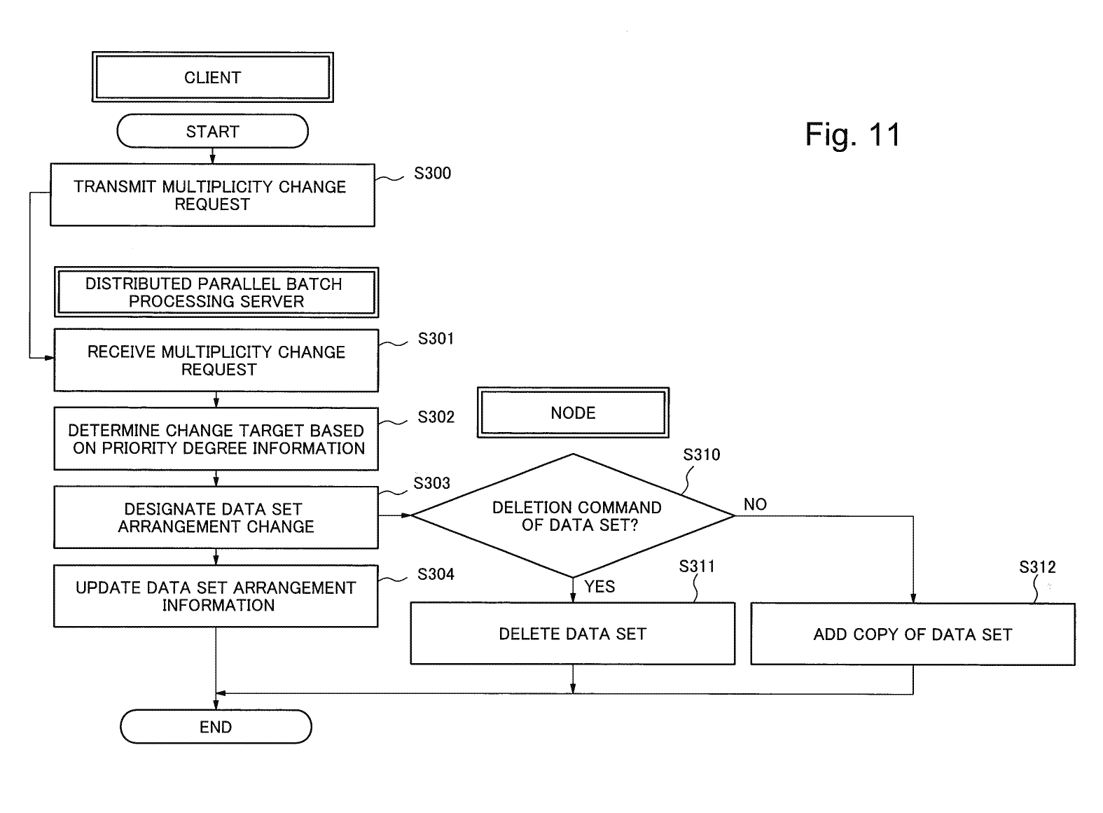

Subsequently, the details of the multiplicity change processing of the data sets will be explained with reference to FIG. 11. The multiplicity change processing of the data set is performed by the job control unit 12 and the distributed data store management unit 13 in the distributed parallel batch processing server 10. FIG. 11 is a flowchart illustrating operation of multiplicity change of the distributed parallel batch processing system according to the second exemplary embodiment of the present invention.

As explained in step S107, the content of the data set arrangement information 17 at this point in time is in conformity with the arrangement of the data set X1 and the data set X2 in the on-memory type data store 3 as shown in FIG. 4. More specifically, the data set X1 exists in the node 20 and the node 21. The data set X2 exists in the node 21 and the node 22. The multiplicity M is “2”. However, the arrangement of the reference data sets Y1 to Y4 and the input data sets A to C which the non-management targets at this point in time may be different from those of FIG. 4. More specifically, the data set group which is the non-management target may have been read into the on-memory type data store 3 in accordance with the processing of the tasks 30 to 32.

First, in the distributed parallel batch processing system, when the client 500 determines to change the multiplicity of the multiplicity management target data sets at any given point in time while the processing of the job continues, the client 500 transmits the multiplicity change request to the distributed parallel batch processing server 10 (step S300). The client 500 designates the change content of the multiplicity M in the multiplicity change request.

In this case, first, an operation in a case where the client 500 commands reduction of the multiplicity by one will be explained. The operation in a case where the increase of the multiplicity is commanded will be explained after the reduction operation is explained. The designation method of designating the change content of the multiplicity M may be other methods such as designating the multiplicity numerical value after the change.

There are various methods according to which the client 500 determines the multiplicity change of the multiplicity management target data set. For example, when the user of the batch processing or the external function (not shown) for managing the progress situation of the batch processing detects delay (advance) of the progress of the batch processing, the external function may transmit a change request for reducing (increasing) the multiplicity via the client 500.

In the distributed parallel batch processing server 10 having received the multiplicity change request, the distributed data store management unit 13 receives the multiplicity change request via the job control unit 12 (step S301).

Subsequently, the distributed data store management unit 13 uses the data set arrangement information 17 and the priority degree information 18 calculated in step S105 (FIG. 9) by the priority degree calculation unit 11 to determine the nodes 20 to 22, which are adopted as the target for changing the arrangement, for each multiplicity management target data set (step S302).

When the reduction of the multiplicity M is commanded in the multiplicity change request, the distributed data store management unit 13 chooses a node of which priority is lower from among the nodes currently storing the multiplicity management target data sets, and adopts the node as the arrangement change (deletion) target. More specifically, first, the distributed data store management unit 13 recognizes that the data set X1 exists in the node 20 and the node 21 on the basis of the data set arrangement information 17. Subsequently, the distributed data store management unit 13 recognizes that, in the priority degree of the data set X1, the priority degree of the node 21 (the priority degree is “2”) is lower than the priority degree of the node 20 (the priority degree is “1”) on the basis of the priority degree information 18 (FIG. 13). As a result, the distributed data store management unit 13 determines that the node 21 is the change (deletion) target of the data set X1. According to the similar method, the distributed data store management unit 13 determines that the node 21 is the change (deletion) target of the data set X2.

Subsequently, the distributed data store management unit 13 commands the input and output management units 60 to 62 of the nodes 20 to 22, which are the change targets, to perform arrangement change (addition or deletion) of a particular multiplicity management target data set for each multiplicity management target data set (step S303). More specifically, the distributed data store management unit 13 commands the input and output management unit 61 of the node 21 to delete the data set X1. Likewise, the distributed data store management unit 13 commands the input and output management unit 61 of the node 21 to delete the data set X2.

In the nodes 20 to 22 commanded to perform the arrangement change of the data set, the input and output management units 60 to 62 carries out, in the memories 40 to 42 of the nodes, the arrangement change of the multiplicity management target data sets according to the command content (step S310).

More specifically, when the command content is to delete the multiplicity management target data set, the input and output management units 60 to 62 delete the designated multiplicity management target data sets (step S311). More specifically, the input and output management unit 61 of the node 21 deletes the data set X1 from the memory 41 in accordance with the deletion command of the data set X1. The input and output management unit 61 deletes the data set X2 from the memory 41 in accordance with the deletion command of the data set X2.

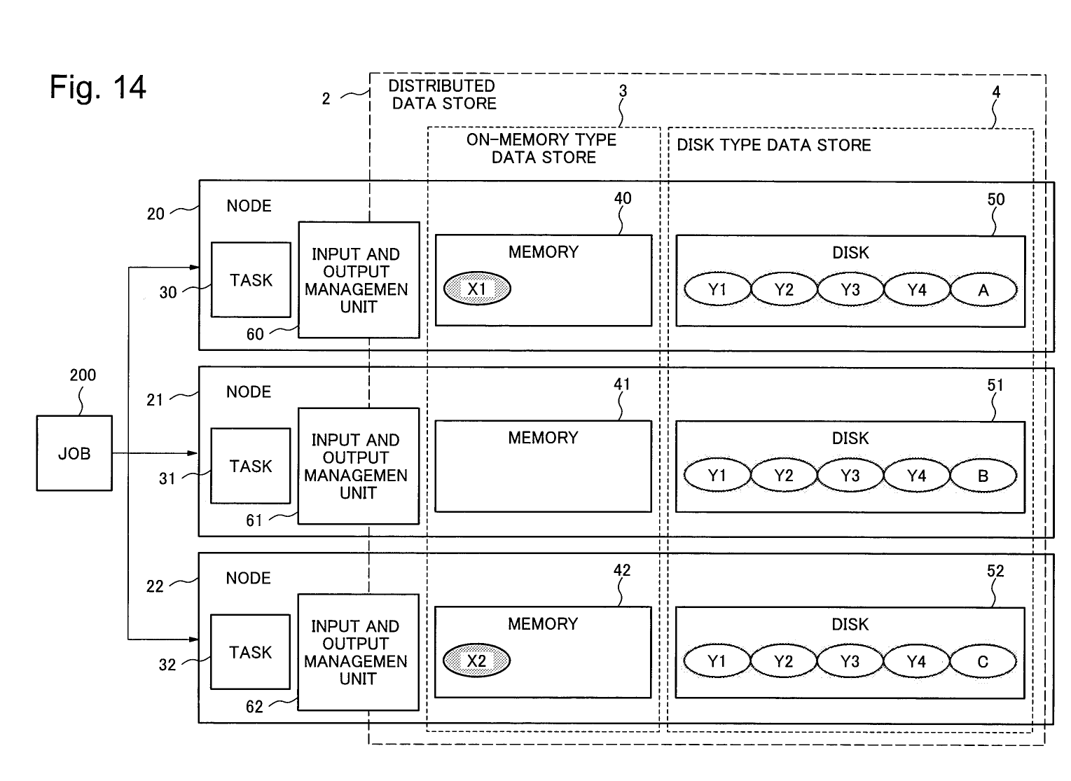

The arrangement state of the data sets in the distributed data store 2 at the point in time when step S311 ended is what is shown in FIG. 14. FIG. 14 is a figure illustrating an example of data arrangement of a distributed data store after multiplicity change according to the second exemplary embodiment of the present invention. As shown in FIG. 14, the data set X1 and the data set X2 which are the multiplicity management target data sets are stored in the node 20 and the node 22, respectively. More specifically, in accordance with the multiplicity change request (reduction), the multiplicity M is reduced from “2” to “1”. It is noted that the arrangement of the reference data sets Y1 to Y4 and the input data sets A to C, which are the non-management targets, may be different from FIG. 14.

On the other hand, in the distributed parallel batch processing server 10, the distributed data store management unit 13 executes the processing described in step S303, and thereafter, updates the data set arrangement information 17 to reflect the arrangement change of the data set which the input and output management units 60 to 62 is commanded to perform (step S304). More specifically, the distributed data store management unit 13 updates the data set arrangement information 17 so as to be in conformity with the arrangement of the data set X1 and the data set X2 in the on-memory type data store 3 as shown in FIG. 14.

As described above, the job control unit 12 and the distributed data store management unit 13 in the distributed parallel batch processing server 10 reduce the multiplicity M in accordance with the multiplicity change request (reduction) from the client 500.

Subsequently, an operation in a case where the multiplicity is commanded to be increased by one will be explained using an example of a case where the client 500 increases the multiplicity M from “1” to “2” in step S300. Assuming that the state of the data set arrangement information 17 and the on-memory type data store 3 at this occasion is associated with FIG. 14.

In the distributed parallel batch processing server 10 having received the multiplicity change request, the distributed data store management unit 13 receives the multiplicity change request via the job control unit 12 (step S301).

Subsequently, the distributed data store management unit 13 uses the data set arrangement information 17 and the priority degree information 18 calculated by the priority degree calculation unit 11 to determine the nodes 20 to 22, which are adopted as the target for changing the arrangement, for each multiplicity management target data set (step S302).

When the addition of the multiplicity M is commanded in the multiplicity change request, the distributed data store management unit 13 chooses a node of which priority is higher from among the nodes currently storing the multiplicity management target data sets, and adopts the node as the arrangement change (addition) target. More specifically, first, the distributed data store management unit 13 recognizes that the data set X1 is not stored in the node 20 and the node 21 on the basis of the data set arrangement information 17. Subsequently, the distributed data store management unit 13 recognizes that, in the priority degree of the data set X1, the priority degree of the node 21 (the priority degree is “2”) is higher than the priority degree of the node 22 (the priority degree is “3”) on the basis of the priority degree information 18 (FIG. 13). As a result, the distributed data store management unit 13 determines that the node 21 is the change (addition) target of the data set X1. According to the similar method, the distributed data store management unit 13 determines that the node 21 is the change (addition) target of the data set X2.

Subsequently, the distributed data store management unit 13 commands the input and output management units 60 to 62 of the nodes 20 to 22, which are the change targets, to perform arrangement change (addition or deletion) of a particular multiplicity management target data set for each multiplicity management target data set (step S303). More specifically, the distributed data store management unit 13 commands the input and output management unit 61 of the node 21 to add the data set X1. Likewise, the distributed data store management unit 13 commands the input and output management unit 61 of the node 21 to add the data set X2.

In the nodes 20 to 22 commanded to perform the arrangement change of the data set, the input and output management units 60 to 62 carries out, in the memories 40 to 42 of the nodes, the arrangement change of the multiplicity management target data sets according to the command content (step S310).

More specifically, when the command content is to add the multiplicity management target data set, the input and output management units 60 to 62 read the designated multiplicity management target data set from the memories 40 to 42 and the like in the other nodes, and add the copies of the target data set to the memories 40 to 42 of the node in question (step S312). More specifically, the input and output management unit 61 of the node 21 copies the data set X1 from the memory 40 to the memory 41 in response to the addition command of the data set X1. The input and output management unit 61 copies the data set X2 from the memory 42 to the memory 41 in response to the addition command of the data set X2.

The arrangement state of the data sets in the distributed data store 2 at the point in time when step S312 ended is what is shown in FIG. 4. As described above, the data set X1 exists in the node 20 and the node 21 with reference to FIG. 4. The data set X2 exists in the node 21 and the node 22. More specifically, in response to the multiplicity change request (increase), the multiplicity M is increased from “1” to “2”. It is noted that the arrangement of the reference data sets Y1 to Y4 and the input data sets A to C, which are the non-management targets, may be different from FIG. 4.

On the other hand, in the distributed parallel batch processing server 10, the distributed data store management unit 13 updates the data set arrangement information 17 to reflect the arrangement change of the data set which the input and output management units 60 to 62 is commanded to perform after the processing described in step S303 has been executed (step S304). This is the same as the case of the multiplicity change request (deletion).

As described above, the job control unit 12 and the distributed data store management unit 13 in the distributed parallel batch processing server 10 increase the multiplicity M in accordance with the multiplicity change request (increase) from the client 500.

The explanation about the multiplicity change processing in the case where the multiplicity M is decreased and increased has been hereinabove explained.

In this case, in order to indicate the effect of the present exemplary embodiment, the effect of the multiplicity management target data set in each reduction method caused on the access performance will be compared using examples of four methods for reducing the multiplicity M from 2 to 1 in FIG. 4. These four methods are the reduction method also explained in the related technique.

First, in FIG. 4, there are four methods for reducing the multiplicity M from 2 to 1. More specifically, the first method is a method for leaving the data set X1 of the node 20 and the data set X2 of the node 21. The second method is a method for leaving the data set 1 of the node 20 and the data set X2 of the node 22. The third method is a method for leaving the data set X1 of the node 21 and the data set X2 of the node 23. The fourth method is a method for leaving the data set X1 of the node 21 and X2.

In the present exemplary embodiment, the reduction method carried out when the multiplicity M is reduced is the second method.

In these four reduction methods, the summation of the access time to each multiplicity management target data set will be compared. In an example of a case where the access performance according to the selected reduction method is most greatly affected, the multiplicity change (reduction) is considered to be executed immediately after the job execution.

The summation of the access times to the multiplicity management target data sets is a value obtained by adding the access times for accessing the data set X1 and the data set X2 during the processing of all the nodes 20 to 22. An access time for accessing a data set indicating a time for accessing a particular data set during job processing in a single node is calculated according to the following expression (3).

(access time for accessing data set)=(access speed)*(the number of accesses) (3)

In this case, the access speed for accessing a data set in a memory of the node in question is considered to be “1”, an access speed for accessing the other nodes is considered to be “5”. This is because, in general, the access speed for accessing a data set becomes higher according to the following order: (memory of the node in question)>(on-memory type data store of another node). The number of accesses uses the predicted access number information for each data set as shown in FIG. 12.

The summation of the access times for accessing the multiplicity management target data sets is a summation of times which all the nodes in the system access the multiplicity management target data sets. Therefore, when the numerical value of the summation of the access times is smaller, the time required for the access can be smaller (the efficiency is better).

First, with regard to the above first method, the summation of the access time to each multiplicity management target data set is calculated. As shown in FIG. 12, the task 30 of the node 20 (hereinafter simply referred to as “node 20”) accesses the data set X1 for 100 times, but does not access the data set X2. Therefore, in the first method, the node 20 accesses the data set X1 in the memory 40 of the node in question 20 (hereinafter simply referred to as “node 20”) for 1000 times. The access time for the node 20 to access the multiplicity management target data set is as follows. More specifically, the access time is as follows.

[access time of node 20] (1*1000)=1000

The node 21 accesses the data set X1 for 500 times, and accesses the data set X2 for 500 times. According to the first method, the node 21 does not include the data set X1, and therefore, the node 21 accesses the data set X1 in another node (i.e. the node 20). Therefore, the access time for the node 21 to access the multiplicity management target data set is as follows. More specifically, it is as follows.

[access time of node 21] (5*500)+(1*500)=3000

Likewise, the access time for the node 22 to access the multiplicity management target data set is as follows. More specifically, it is as follows.

[access time of node 22] (5*200)+(5*800)=5000

The summation of the access time to each multiplicity management target data set according to the first method (hereinafter simply referred to as “total access time according to first method”) will be as described below as a result of adding the access times of the nodes 20 to 22. More specifically, it is as follows.

[total access time] 1000+3000+5000=9000

Subsequently, the total access time for accessing each multiplicity management target data set will be calculated also according to the second to the fourth methods. The calculation method is the same as the above, and therefore, only the expression showing the calculation process will be described below.

Described below is the calculation expression for calculating the total access time according to the above second method. More specifically, it is as follows.

[access time of node 20] (1*1000)=1000

[access time of node 21] (5*500)+(5*500)=5000

[access time of node 22] (5*200)+(1*800)=1800

Therefore,

[total access time] 1000+5000+1800=7800

Described below is the calculation expression for calculating the total access time according to the above third method. More specifically, it is as follows.

[access time of node 20] (5*1000)=5000

[access time of node 21] (1*500)+(5*500)=3000

[access time of node 22] (5*200)+(1*800)=1800

Therefore,

[total access time] 5000+3000+18000=9800

Described below is the calculation expression for calculating the total access time according to the above fourth method. More specifically, it is as follows.

[access time of node 20] (5*1000)=5000

[access time of node 21] (1*500)+(1*500)=1000

[access time of node 22] (5*200)+(5*800)=5000

Therefore,

[total access time] 5000+1000+5000=11000

As described above, when the numerical values of the total access times according to the four reduction methods are compared, the smallest total access time is the second method (the reduction method carried out in the present exemplary embodiment). More specifically, according to the present exemplary embodiment, when the multiplicity M is changed in the middle of the processing of a job, the multiplicity M can be changed to achieve an arrangement of the data sets so as to avoid reduction of the access efficiency for accessing the multiplicity management target data sets as much as possible.

This is because the priority degree calculation unit 11 calculates the priority degree information 18 on the basis of the data set usage related information which is information indicating the degree of the effect given to the access efficiency for accessing the multiplicity management target data set. Further, the distributed data store management unit 13 selects a node adopted as the change target of the multiplicity M for each multiplicity management target data set on the basis of the priority degree information 18. More specifically, the priority degree calculation unit 11 calculates the priority degree information 18 on the basis of an access prediction number which is information indicating the degree of necessity of access to the multiplicity management target data set. Further, this is because the distributed data store management unit 13 can select a node adopted as the target for changing the arrangement for each multiplicity management target data set on the basis of the priority degree information 18.

According to the present exemplary embodiment, the change of the multiplicity M in the middle of the processing of the job can be quickly done at any given point in time. This is because the distributed data store management unit 13 can quickly select the change target node since the node adopted as the change target of the multiplicity M is determined for each multiplicity management target data set on the basis of the priority degree information 18 calculated in advance. Therefore, when, for example, the distributed data store management unit 13 continuously executes the job processing, the arrangement of the data sets for the previous job is used as it is, so that the job execution preparation period is reduced. Further, this makes the following operation easier: only when there occurs a problem with progress of the job, the distributed data store management unit 13 tries to adjust the progress by changing the multiplicity M.

In the present exemplary embodiment, after the job control unit 12 carries out the processing for allocating a task to a node (step S103), the priority degree calculation unit 11 executes the application analysis processing (step S104) and the priority degree calculation processing (step S105). These orders of processing may be changed. For example, after step S102, the priority degree calculation unit 11 performs the application analysis processing (step S104) and the priority degree calculation processing (step S105) in advance. Thereafter, the job control unit 12 may perform the processing for allocating a task to a node (step S103) in view of the calculated priority degree information 18.

In this case, the priority degree calculation unit 11 does not calculate the access prediction number and the priority degree information while the nodes 20 to 22 are adopted as the target in the application analysis processing and the priority degree calculation processing, and instead, the priority degree calculation unit 11 performs the above calculation processing while the tasks A to C processing the input data sets A to C are adopted as temporary calculation target. Then, during the allocation processing for allocating the final task to the node, the job control unit 12 allocates the temporary tasks A to C as well as the input data sets A to C to the nodes 20 to 22, respectively.

A point in time when the priority degree calculation unit 11 calculates the priority degree information 18 may be any point in time before the client transmits a multiplicity change request. Further, the priority degree calculation unit 11 may update the priority degree information 18 at any given time during the processing execution of the job.

Each function unit in the distributed parallel batch processing server 10 and various kinds of data groups stored in the disk 14 need not be necessarily placed on an information processing device different from the nodes 20 to 22 and the master data server 100. Further, if required mutual communication and sharing of information can be done as necessary, each function unit of the distributed parallel batch processing server 10 and each piece of data stored in the disk 14 need not be provided in a single information processing device.

### Modification of Second Exemplary Embodiment

It is noted that the following modifications can be considered as the modifications of the present exemplary embodiment.

For example, in the present exemplary embodiment, the batch processing is considered to include a single job, but the present exemplary embodiment can also be applied to a case where a batch processing includes multiple jobs. This modification is based on the assumption that there are multiple jobs (i.e., a case where there are multiple application programs 15). One of methods for applying the present exemplary embodiment to this case is considered to be a method for calculating a piece of priority degree information 18 while all the jobs included in the batch processing are adopted as the target. However, when there is a big difference in the processing content included in each job, such priority degree information 18 may not be compatible with many jobs. Therefore, when the multiplicity M is changed, the processing efficiency may decrease in the arrangement of the multiplicity management target data set determined on the basis of such priority degree information 18.

Therefore, the distributed parallel batch processing server 10 may provide multiple pieces of priority degree information 18 for the batch processing successively executing multiple jobs. More specifically, the priority degree calculation unit 11 performs application analysis on the targets of the application programs 15 associated with multiple jobs in step S104. As a result, the priority degree calculation unit 11 calculates the priority degree information 18 which is different for each application program 15 (hereinafter described as “priority degree information 18 for each job”). Then, the priority degree calculation unit 11 holds the priority degree information 18 for each job into the disk 14. When the job control unit 12 receives a multiplicity change request from the client 500 after the start of execution of the job, the job control unit 12 provides information about the multiplicity change request as well as information about the job being executed at that moment to the distributed data store management unit 13. The distributed data store management unit 13 determines the nodes 20 to 22 adopted as the change target of the multiplicity M on the basis of the “priority degree information 18 for each job” associated with the job being executed (step S302).

As described above, the distributed parallel batch processing server 10 includes multiple pieces of priority degree information 18 for the jobs with regard to the batch processing successively executing multiple jobs, so that the same effects as the present exemplary embodiment can be provided to each job included in the batch processing.

In another modification, different priority degree information 18 can be used depending on the type of the multiplicity change of “reduction” and “increase” of the multiplicity M. For example, when the multiplicity M is increased, the nodes 20 to 22 read designated multiplicity management target data sets from the memories 40 to 42 and the like in other nodes, and adds the copies thereof to the memories 40 to 42 of the node in question (step S312).

More specifically, until the increase of the multiplicity M is realized, a time to complete the transfer (copy) of the multiplicity management target data sets in the nodes 20 to 22 is required. For this reason, when the distributed data store management unit 13 commanded a node of which data transfer speed is particularly slow to add the multiplicity management target data set, it may take more time to perform the increase processing of the multiplicity M as compared with the case where addition to another node is commanded. Accordingly, in the processing for calculating the priority degree information for each multiplicity management target data set (step S105), the priority degree calculation unit 11 may use the data transfer speed between the nodes as the second data set usage related information 330 in the priority degree calculation expression.

Assuming that, before step S105, the priority degree calculation unit 11 obtains information about the data transfer speed between the nodes from the file stored in the disk 14 in advance, the outside of the system, and the like. The priority degree calculation expression at this occasion, is what is shown in the expression (4) below. More specifically,

f(x)=a1x1+a2x2 (4)

In this case, like the present exemplary embodiment, “x1” is “the predicted number of accesses for each data set”. “x2” indicates “the numerical value based on the data transfer speed between the node of the calculation target and another node”. On the other hand, values suitable for weighting “the predicted number of accesses for each data set” and “the numerical value based on the data transfer speed between the node of the calculation target and another node” are employed according to the situation of the system as “a1” and “a2” which are coefficients of the types of the data set usage related information 330. The priority degree calculation unit 11 uses the second priority degree information 18 calculated on the basis of these two pieces of data set usage related information 330, so that the distributed data store management unit 13 can reduce the priority degree of the node which takes more time to perform copying. As a result, the distributed data store management unit 13 can select an arrangement in which the increase of the multiplicity M can be completed in a shorter time.

However, when the multiplicity M is reduced in reduced in the present modification, the node having received the arrangement change command of the data set from the distributed data store management unit 13 deletes the designated multiplicity management target data set (step S311), but does not refer to the data sets in other nodes. Therefore, in general, the data transfer speed between the nodes does not affect the time of completion of the reduction of the multiplicity M. Therefore, the distributed data store management unit 13 applies the second priority degree information 18 in a case of increase of the multiplicity M, and on the other hand, in a case of reduction of the multiplicity M, for example, the priority degree information 18 calculated in the second exemplary embodiment may be applied. As described above, the distributed parallel batch processing server 10 use multiple pieces of priority degree information 18 according to the content of the multiplicity change request (reduction or increase). Therefore, in the present modification, the multiplicity change method suitable for the content of the multiplicity change request can be realized.

Each unit shown in FIGS. 1 to 3 in each exemplary embodiment explained above and the modifications thereof (which may be hereinafter simply referred to as “each exemplary embodiment and the like”) may be understood as software program function (processing) unit (software module). However, the division of each unit as shown in these drawings is the configuration for the sake of explanation, and in actual implementation, various configurations may be considered. Hereinafter, an example of hardware environment in such case will be explained with reference to FIG. 15.

FIG. 15 is a figure illustrating an example of a configuration of a computer (information processing device) that can be applied to a distributed parallel batch processing system according to each exemplary embodiment and the modifications thereof of the present invention. More specifically, FIG. 15 is a configuration of a computer that can achieve at least one of distributed parallel batch processing server 10, nodes 20 to 22, master data server 100, data base 110, data set multiplicity change device 300, node 320, client 500 according to each exemplary embodiment and the like explained above, and illustrates a hardware environment that can achieve each function of the exemplary embodiment and the like explained above.

A computer 900 as shown in FIG. 15 includes such a configuration that includes a CPU (Central Processing Unit) 901, a ROM (Read Only Memory) 902, a RAM (Random Access Memory) 903, a communication interface (I/F) 904, a display 905, and a hard disk device (HDD) 906, and these are connected via a bus 907. The computer as shown in FIG. 15 functions as any one of the distributed parallel batch processing server 10, nodes 20 to 22, the master data server 100, the data base 110, the data set multiplicity change device 300, and the node 320. However, the display 905 need not be provided at all times. The communication interface 904 is general communication means for realizing communication between the computer 900 and an external device via the network 1000. The hard disk device 906 stores a program group 906A and various kinds of storage information 906B.

For example, the program group 906A is a computer program for achieving the function associated with each block (each unit) as shown in FIGS. 1 to 3 explained above. For example, various kinds of storage information 906B are the priority degree information 18, 311, the data set arrangement information 17, 312, the data sets 70, 80, 322 shown in FIG. 1 and FIG. 3, the application program 15 and the job definition information 16 shown in FIG. 3, the master data set 120 as shown in FIGS. 2 and 3, and the like. In such hardware configuration, the CPU 901 controls the operation of the entire computer 900.

The present invention explained using the above exemplary embodiment and the like as examples is achieved by providing a computer program capable of realizing the functions of the block configuration diagram (FIG. 1 to FIG. 3) or the flowchart (FIG. 9 to FIG. 11) referred to in the explanation about each exemplary embodiment and the like, and thereafter, reading the computer program to the CPU 901 of the hardware and executing the computer program. The computer program provided into the computer may be stored to a nonvolatile storage device (storage medium) such as a readable and writable temporary storage memory 903 or a hard disk device 106.

For example, in a case of a recording medium recording a computer program for operation control of a computer operating as a data set multiplicity change device, a program causing the computer to execute subsequent processing is permanently recorded. The processing is, firstly, priority degree calculation processing for calculating priority degree information representing the order of multiple nodes which are to store data sets on the basis of data set usage related information which is information related to usage of data sets referred to in parallel processing executed by multiple nodes. The processing is, secondly, multiplicity change processing for changing the multiplicity of data sets by changing the number of at least one or more data sets held in a distributed manner in multiple nodes on the basis of the priority degree information and the data set arrangement information indicating particular node holding a data set in a storage area.

In the above case, currently general procedures can be employed as a providing method of a computer program into each device. The general procedures include a method for installing the computer program into the device via various kinds of recording media such as a CD-ROM and a method for downloading the computer program from the outside via a communication circuit 1000 such as the Internet. In such case, the present invention may be understood as including codes included such computer program or a computer readable storage medium for storing such codes.

In the present invention, some or all of the above exemplary embodiments and the modifications thereof may be described as shown in the following supplementary notes, but are not limited to the following supplementary notes.

### (Supplementary Note 1)

A data set multiplicity change device includes:

priority degree calculation means for calculating priority degree information representing an order of a plurality of nodes into which data sets are to be stored, on the basis of data set usage related information including information related to usage of the data sets referred to in a parallel processing executed by the plurality of nodes; and

multiplicity management means for performing multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

### (Supplementary Note 2)

The data set multiplicity change device according to Supplementary Note 1, wherein the priority degree calculation means generates at least a part of the data set usage related information, on the basis of an application program describing a processing content of the parallel processing and information about data sets used in the parallel processing.

### (Supplementary Note 3)

The data set multiplicity change device according to Supplementary Note 1 or 2, wherein the data set usage related information includes predicted access number information for each data set representing a number of times the data set is referred to when the plurality of nodes perform the parallel processing.

### (Supplementary Note 4)

The data set multiplicity change device according to any one of Supplementary Note 1 to 3, wherein

when the parallel processing includes processing for successively executing a plurality of jobs,
the priority degree calculation means calculates, for each job, the priority degree information associated with the plurality of jobs, and
the multiplicity management means carries out the multiplicity change processing on the basis of the priority degree information associated with the job executed by the node when the multiplicity change processing is carried out.

### (Supplementary Note 5)

The data set multiplicity change device according to any one of Supplementary Note 1 to 4, wherein

the priority degree calculation means calculates first priority degree information associated with multiplicity reduction for reducing the number of data sets held in a multiplexed manner, and second priority degree information associated with multiplicity increase for increasing the number of at least one or more data sets held therein, and

the multiplicity management means carries out the multiplicity change processing on the basis of the first priority degree information when the multiplicity reduction is performed in the multiplicity change processing, and the multiplicity management means carries out the multiplicity change processing on the basis of the second priority degree information when the multiplicity increase is performed.

### (Supplementary Note 6)

The data set multiplicity change device according to Supplementary Note 5, wherein the priority degree calculation means

incorporates the predicted access number information for each data set into the data set usage related information when the first priority degree information is calculated, and

incorporates the predicted access number information for each data set and information about a data transfer speed between nodes into the data set usage related information when the second priority degree information is calculated.

### (Supplementary Note 7)

A server includes:

a data set multiplicity change device according to any one of Supplementary Note 1 to 6,

wherein parallel processing of the jobs performed by the plurality of nodes is controlled.

### (Supplementary Note 8)

A data set multiplicity change method includes:

calculating, using an information processing device, priority degree information representing an order of a plurality of nodes into which data sets are to be stored, on the basis of data set usage related information including information related to usage of the data sets referred to in a parallel processing executed by the plurality of nodes, and

performing multiplicity change processing to change a multiplicity of the data sets by changing, using the information processing device, a multiplicity of the data set by changing the number of at least one or more data sets held in the plurality of nodes in a distributed manner on the basis of the priority degree information and data set arrangement information indicating a particular node holding the data sets in a storage area thereof.

### (Supplementary Note 9)

The data set multiplicity change method according to Supplementary Note 8, wherein when the priority degree information is calculated, at least a part of the data set usage related information is generated on the basis of an application program describing a processing content of the parallel processing and information about data sets used in the parallel processing.

### (Supplementary Note 10)

The data set multiplicity change method according to Supplementary Note 8 or 9, wherein the data set usage related information includes predicted access number information for each data set representing a number of times the data set is referred to when the plurality of nodes perform the parallel processing.

### (Supplementary Note 11)

The data set multiplicity change method according to any one of Supplementary Note 8 to 10, wherein

when the parallel processing includes processing for successively executing a plurality of jobs,
priority degree information associated with the plurality of jobs is calculated for each job when the priority degree information is calculated, and
the multiplicity change processing is carried out on the basis of the priority degree information associated with the job executed by the node when the multiplicity change processing is carried out.

### (Supplementary Note 12)

The data set multiplicity change method according to any one of Supplementary Note 8 to 11, wherein

when the priority degree information is calculated,
first priority degree information associated with multiplicity reduction for reducing the number of data sets held in a multiplexed manner and second priority degree information associated with multiplicity increase for increasing the number of at least one or more data sets held therein are calculated, and

when the multiplicity change processing is carried out,
the multiplicity change processing is carried out on the basis of the first priority degree information when the multiplicity reduction is performed, and
the multiplicity change processing is carried out on the basis of the second priority degree information when the multiplicity increase is performed.

### (Supplementary Note 13)

The data set multiplicity change method according to Supplementary Note 12, wherein

the predicted access number information for each data set is incorporated into the data set usage related information when the first priority degree information is calculated, and

the predicted access number information for each data set and information about a data transfer speed between nodes are incorporated into the data set usage related information when the second priority degree information is calculated.

### (Supplementary Note 14)

A storage medium for storing a computer program for control of a computer operating as a data set multiplicity change device,

wherein the computer program causes the computer to execute

priority degree calculation processing for calculating priority degree information representing an order of a plurality of nodes into which data sets are to be stored, on the basis of data set usage related information including information related to usage of the data sets referred to in a parallel processing executed by the plurality of nodes; and

performing multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

### (Supplementary Note 15)

The storage medium for storing the computer program according to Supplementary Note 14, wherein the priority degree calculation processing generates at least a part of the data set usage related information, on the basis of an application program describing a processing content of the parallel processing and information about data sets used in the parallel processing.

### (Supplementary Note 16)

The storage medium for storing the computer program according to Supplementary Note 14 or 15, wherein the data set usage related information includes predicted access number information for each data set representing a number of times the data set is referred to when the plurality of nodes perform the parallel processing.

### (Supplementary Note 17)

The storage medium for storing the computer program according to any one of Supplementary Note 14 to 16, wherein when the parallel processing includes processing for successively executing a plurality of jobs,

the priority degree calculation processing calculates, for each job, priority degree information associated with the plurality of jobs, and

the multiplicity management processing changes the multiplicity of the data set on the basis of the priority degree information associated with the job executed by the node.

### (Supplementary Note 18)

The storage medium for storing the computer program according to any one of Supplementary Note 14 to 17, wherein the priority degree calculation processing calculates first priority degree information associated with multiplicity reduction for reducing the number of data sets held in a multiplexed manner, and second priority degree information associated with multiplicity increase for increasing the number of at least one or more data sets held therein, and

the multiplicity management processing changes the multiplicity of the data set on the basis of the first priority degree information when the multiplicity reduction is performed, and the multiplicity change processing changes the multiplicity of the data set on the basis of the second priority degree information when the multiplicity increase is performed.

### (Supplementary Note 19)

The storage medium for storing the computer program according to Supplementary Note 18, wherein the priority degree calculation processing

incorporates the predicted access number information for each data set into the data set usage related information when the first priority degree information is calculated, and

incorporates the predicted access number information for each data set and information about a data transfer speed between nodes into the data set usage related information when the second priority degree information is calculated.

The invention of the present application has been hereinabove explained with reference to the above exemplary embodiments and the like but the invention of the present application is not limited to the above exemplary embodiments. The configuration and the details of the invention of the present application can be changed within the scope of the invention of the present application in various manners that can be understood by a person skilled in the art.

The present invention has been hereinabove explained using the above exemplary embodiments as typical examples. However, the present invention is not limited to the above exemplary embodiments. More specifically, various aspects that can be understood by a person skilled in the art can be applied to the present invention within the scope of the present invention.

This application claims the priority based on Japanese Patent Application No. 2013-019403 filed on Feb. 4, 2013, and the entire disclosure thereof is incorporated herein by reference.

### REFERENCE SIGNS LIST

1 distributed parallel batch processing system
2 distributed data store
3 on-memory type data store
4 disk type data store
10 distributed parallel batch processing server
11 priority degree calculation unit
12 job control unit
13 distributed data store management unit
14 disk
15 application program
16 job definition information
17 data set arrangement information
18 priority degree information
20 to 22 node
30 to 32 task
40 to 42 memory (storage area)
50 to 52 disk
60 to 62 input and output management unit
70 to 72, 80 to 82 data set
100 master data server
110 data base
120 master data set
130 master data management unit
200 job
300 data set multiplicity change device
301 priority degree calculation unit
302 multiplicity management unit
311 priority degree information
312 data set arrangement information
320 node
321 memory (storage area)
322 data set
330 data set usage related information
500 client
900 information processing device (computer)
901 CPU
902 ROM
903 RAM
904 communication interface (I/F)
905 display
906 hard disk device (HDD)
906A program group
906B various kinds of storage information
907 bus
1000 network (communication network)

What is claimed is:

1. A data set multiplicity change device comprising:
priority degree calculation unit which calculates priority degree information representing an order of a plurality of nodes into which data sets are to be stored, on the basis of data set usage related information including information related to usage of the data sets referred to in a parallel processing executed by the plurality of nodes; and
multiplicity management unit which performs multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

2. The data set multiplicity change device according to claim 1, wherein the priority degree calculation unit generates at least a part of the data set usage related information, on the basis of an application program describing a processing content of the parallel processing and information about data sets used in the parallel processing.

3. The data set multiplicity change device according to claim 1, wherein the data set usage related information includes predicted access number information for each data set representing a number of times the data set is referred to when the plurality of nodes perform the parallel processing.

4. The data set multiplicity change device according to claim 1, wherein
when the parallel processing includes processing for successively executing a plurality of jobs,
the priority degree calculation unit calculates, for each job, the priority degree information associated with the plurality of jobs, and
the multiplicity management unit carries out the multiplicity change processing on the basis of the priority degree information associated with the job executed by the node.

5. The data set multiplicity change device according to claim 1, wherein
the priority degree calculation unit calculates first priority degree information associated with multiplicity reduction for reducing the number of data sets held in a multiplexed manner, and second priority degree information associated with multiplicity increase for increasing the number of at least one or more data sets held therein, and
the multiplicity management unit carries out the multiplicity change processing on the basis of the first priority degree information when the multiplicity reduction is performed in the multiplicity change processing, and the multiplicity management unit carries out the multiplicity change processing on the basis of the second priority degree information when the multiplicity increase is performed.

6. The data set multiplicity change device according to claim 5, wherein the priority degree calculation unit
incorporates the predicted access number information for each data set into the data set usage related information when the first priority degree information is calculated, and
incorporates the predicted access number information for each data set and information about a data transfer speed between nodes into the data set usage related information when the second priority degree information is calculated.

7. (canceled)

8. A data set multiplicity change method comprising:
calculating, using an information processing device, priority degree information representing an order of a plurality of nodes into which data sets are to be stored, on the basis of data set usage related information including information related to usage of the data sets referred to in a parallel processing executed by the plurality of nodes, and
performing multiplicity change processing to change a multiplicity of the data sets by changing, using the information processing device, a multiplicity of the data set by changing the number of at least one or more data sets held in the plurality of nodes in a distributed manner on the basis of the priority degree information and data set arrangement information indicating a particular node holding the data sets in a storage area thereof.

9. The data set multiplicity change method according to claim 8, wherein when the priority degree information is calculated, at least a part of the data set usage related information is derived on the basis of an application program describing a processing content of the parallel processing and information about data sets used in the parallel processing.

10. The data set multiplicity change method according to claim 8, wherein the data set usage related information includes predicted access number information for each data set representing a number of times the data set is referred to when the plurality of nodes perform the parallel processing.

11. The data set multiplicity change method according to claim 8, wherein
when the parallel processing includes processing for successively executing a plurality of jobs,
priority degree information associated with the plurality of jobs is calculated for each job when the priority degree information is calculated, and
the multiplicity change processing is carried out on the basis of the priority degree information associated with the job executed by the node.

12. The data set multiplicity change method according to claim 8, wherein
when the priority degree information is calculated,
first priority degree information associated with multiplicity reduction for reducing the number of data sets held in a multiplexed manner and second priority degree information associated with multiplicity increase for increasing the number of at least one or more data sets held therein are calculated, and
when the multiplicity change processing is carried out,
the multiplicity change processing is carried out on the basis of the first priority degree information when the multiplicity reduction is performed, and
the multiplicity change processing is carried out on the basis of the second priority degree information when the multiplicity increase is performed.

13. The data set multiplicity change method according to claim 12, wherein
the predicted access number information for each data set is incorporated into the data set usage related information when the first priority degree information is calculated, and
the predicted access number information for each data set and information about a data transfer speed between nodes are incorporated into the data set usage related information when the second priority degree information is calculated.

14. A non-transitory computer readable medium for storing a computer program which causes a computer to execute:
priority degree calculation processing for calculating priority degree information representing an order of a plurality of nodes into which data sets are to be stored, on the basis of data set usage related information including information related to usage of the data sets referred to in a parallel processing executed by the plurality of nodes; and
performing multiplicity change processing to change a multiplicity of the data sets by changing the number of at least one or more data sets held in the plurality of nodes in a distributed manner on the basis of the priority degree information and data set arrangement information indicating a particular node holding the data sets in a storage area thereof.

15. The computer readable medium for storing the computer program according to claim 14, wherein the priority degree calculation processing generates at least a part of the data set usage related information, on the basis of an application program describing a processing content of the parallel processing and information about data sets used in the parallel processing.

16. The computer readable medium for storing the computer program according to claim 14, wherein the data set usage related information includes predicted access number information for each data set representing a number of times the data set is referred to when the plurality of nodes perform the parallel processing.

17. The computer readable medium for storing the computer program according to any one of claim 14, wherein when the parallel processing includes processing for successively executing a plurality of jobs,
the priority degree calculation processing calculates, for each job, priority degree information associated with the plurality of jobs, and
the multiplicity management processing changes the multiplicity of the data set on the basis of the priority degree information associated with the job executed by the node.

18. The computer readable medium for storing the computer program according to claim 14, wherein the priority degree calculation processing calculates first priority degree information associated with multiplicity reduction for reducing the number of data sets held in a multiplexed manner, and second priority degree information associated with multiplicity increase for increasing the number of at least one or more data sets held therein, and
the multiplicity management processing changes the multiplicity of the data set on the basis of the first priority degree information when the multiplicity reduction is performed, and the multiplicity change processing changes the multiplicity of the data set on the basis of the second priority degree information when the multiplicity increase is performed.

19. The computer readable medium for storing the computer program according to claim 18, wherein the priority degree calculation processing
incorporates the predicted access number information for each data set into the data set usage related information when the first priority degree information is calculated, and
incorporates the predicted access number information for each data set and information about a data transfer speed between nodes into the data set usage related information when the second priority degree information is calculated.
